(19) United States
(12) Patent Application Publication
(10) Pub. No.: US 2009/0009471 A1
(43) Pub. Date: Jan. 8, 2009

(54) INPUT APPARATUS, CONTROL APPARATUS, CONTROL SYSTEM, AND CONTROL METHOD

(75) Inventors: Kazuyuki Yamamoto, Kanagawa (JP); Toshio Mamiya, Tokyo (JP); Hidetoshi Kabasawa, Saitama (JP); Katsuhiko Yamada, Tokyo (JP); Hideaki Kumagai, Kanagawa (JP)

Correspondence Address: BELL, BOYD & LLOYD, LLP, P. O. BOX 1135, CHICAGO, IL, 60690, US

(73) Assignee: SONY CORPORATION, TOKYO (JP)

(21) Appl. No.: 12/166,930

(22) Filed: Jul. 2, 2008

(30) Foreign Application Priority Data
Jul. 4, 2007 (JP) 2007-176757

(51) Int. Cl. G09G 5/08

(52) U.S. Cl. 345/158

(57) ABSTRACT

An input apparatus outputting input information for controlling a movement of a user interface displayed on a screen is provided. The input apparatus includes: an angular velocity output unit for outputting a first angular velocity about a first axis, a second angular velocity about a second axis. A third angular velocity about a third axis; a combination calculates unit calculating a first combined angular velocity as a combination result of two angular velocities obtained by respectively multiplying the second and third angular velocities by two migration coefficients of a predetermined ratio. An output unit outputs, as the input information, information on the first angular velocity for controlling a movement of the user interface on the screen in an axial direction corresponding to the second axis and information on the first combined angular velocity for controlling the movement of the user interface on the screen in an axial direction corresponding to the first axis.

### CROSS REFERENCES TO RELATED APPLICATIONS

The present application claims priority to Japanese Patent Application JP 2007-176757 filed in the Japanese Patent Office on Jul. 4, 2007, the entire contents of which being incorporated herein by reference.

### BACKGROUND

The present disclosure relates to an input apparatus for 3-dimensional operations, which is used to operate a GUI (Graphical User Interface), a control apparatus for controlling the GUI based on operational information of the input apparatus, a control system including the input apparatus and the control apparatus, and a control method therefor.

Pointing devices, particularly a mouse and a touchpad, are used as controllers for GUIs widely used in PCs (Personal Computers). Not just as HIs (Human Interfaces) of PCs as in related art, the GUIs are now starting to be used as an interface for AV equipment and game machines used in living rooms etc. with, for example, televisions as image media. Various pointing devices that a user is capable of operating 3-dimensionally are proposed as controllers for the GUIs of this type (see, for example, Japanese Patent Application Laid-open No. 2001-56743 (paragraphs (0030) and (0031), FIG. 3) and Japanese Patent No. 3,748,483 (paragraphs (0033) and (0041), FIG. 1.

Japanese Patent Application Laid-open No. 2001-56743 (paragraphs (0030) and (0031) discloses an input apparatus including angular velocity gyroscopes of two axes, i.e., two angular velocity sensors. Each angular velocity sensor is a vibration-type angular velocity sensor. For example, upon application of an angular velocity with respect to a vibrating body piezoelectrically vibrating at a resonance frequency, Colioris force is generated in a direction perpendicular to a vibration direction of the vibrating body. The Colioris force is in proportion with the angular velocity, so detection of the Colioris force leads to detection of the angular velocity. The input apparatus of Japanese Patent Application Laid-open No. 2001-56743 (paragraphs (0030) and (0031) detects angular velocities about two orthogonal axes by the angular velocity sensors, generates, based on the angular velocities, a command signal as positional information of a cursor or the like displayed by display means, and transmits the command signal to the control apparatus.

Japanese Patent No. 3,748,483 (paragraphs (0033) and (0041), FIG. 1, discloses a pen-type input apparatus including three acceleration sensors (of three axes) and three angular velocity sensors (of three axes) (gyro). The pen-type input apparatus executes various types of operational processing based on signals obtained by the three acceleration sensors and the three angular velocity sensors, to obtain a positional angle of the pen-type input apparatus.

Incidentally, in related art, a display aspect ratio of televisions and PCs has been 4:3, which is horizontally expanded to 16:9 in recent years as horizontally long display. Thus, when a user attempts to move the UI on the horizontally long screen using the pointing device, it is more difficult to move the UI in a horizontal direction than a vertical direction since the horizontal direction on the screen is longer.

For example, when angular velocity values detected by the angular velocity sensors of at least two axes of a horizontal axis and a vertical axis are used to control the movement of the UI, the user often moves the pointing device mainly using a wrist as a fulcrum. However, when taking into account a movable range of the wrist by which a user is capable of comfortably operating the pointing device while holding it, the screen with the aspect ratio of 16:9 is too long in the horizontal direction as compared to the vertical direction.

A display that can realize full-screen display of a screen additionally longer in the horizontal direction than the screen with the aspect ratio of 16:9 as in some movies may be expected of productization in the future. Further, depending on contents of games and the like, there are vertically long screens instead of the horizontally long screens.

In view of the above-mentioned circumstances, there is a need for an input apparatus, a control apparatus, a control system, and a control method therefor that are capable of readily moving the UI in a predetermined direction.

### SUMMARY

According to an embodiment, there is provided an input apparatus configured to output input information for controlling a movement of a UI (user interface) displayed on a screen and includes angular velocity output means, combination calculation means, and output means. The angular velocity output means outputs a first angular velocity about a first axis, a second angular velocity about a second axis different from the first axis, and a third angular velocity about a third axis perpendicular to both the first axis and the second axis. The combination calculation means calculates a first combined angular velocity obtained as a result of combining two angular velocities, which are obtained by respectively multiplying the second angular velocity and the third angular velocity by two migration coefficients represented by a predetermined ratio. The output means outputs, as the input information, information on the first angular velocity for controlling a movement of the UI on the screen in an axial direction corresponding to the second axis and information on the first combined angular velocity for controlling the movement of the UI on the screen in an axial direction corresponding to the first axis.

In the embodiment, the movement of the UI on the screen in the first-axis direction is controlled in accordance with the first combined angular velocity obtained as a result of combining the two angular velocities, that is, a second operational angular velocity and a third operational angular velocity, which are obtained by respectively multiplying the second angular velocity and the third angular velocity by the migration coefficients represented by the predetermined ratio, instead of using only one of the second operational angular velocity and the third operational angular velocity. Because the third axis is perpendicular to the first axis and the second axis, the movement of the UI in the first-axis direction is controlled with at least one of an operation of causing the input apparatus to rotate about the third axis and an operation of moving the input apparatus in the first-axis direction, for example. Accordingly, it is possible to reduce a movement amount when the user moves the input apparatus in the first-axis direction and to thus readily move the UI in the first-axis direction.

The expression “calculating” includes both meanings of calculating a value by a logical operation and reading out any of various to-be-calculated values stored as a correspondence table in a memory or the like.

The axis corresponding to the second axis is an axis substantially parallel to the second axis in a state where a plane containing the first axis and the second axis is close to being in parallel with the screen, that is, a state where the input apparatus is in an ideal initial position at which the input apparatus is not tilted about the third axis. The same holds true for the axis corresponding to the first axis.

In the embodiment, the input apparatus further includes angle calculation means and rotation correction means. The angle calculation means calculates an angle about the third axis from an absolute vertical axis based on the third angular velocity. The rotation correction means corrects the first angular velocity and the second angular velocity output by the angular velocity output means by rotational coordinate conversion that corresponds to the calculated angle to obtain a first correction angular velocity and a second correction angular velocity, and outputs information on the first correction angular velocity and the second correction angular velocity. In the input apparatus, the combination calculation means calculates a second combined angular velocity obtained as a result of combining two angular velocities, which are obtained by respectively multiplying the second correction angular velocity and the third angular velocity by the two migration coefficients. Further, the output means outputs information on the second combined angular velocity and the first correction angular velocity as the input information. In the embodiment, the movement of the UI is controlled based on the first angular velocity and the second angular velocity. Therefore, when the initial position of the input apparatus is tilted about the third axis from the ideal initial position, there is a fear in that the first axis and the second axis may deviate from the axes respectively corresponding to the first axis and the second axis. However, such a problem is eliminated by correcting the first angular velocity and the second angular velocity by the rotational coordinate conversion corresponding to the angle calculated by the angle calculation means.

In the input apparatus according to the embodiment, the angle calculation means includes integration means for calculating the angle through an integration operation of the third angular velocity, and reset means for resetting an integration value obtained by the integration means. Integration errors can be eliminated by resetting the integration value. A reset timing may be determined by the user or may be determined by the input apparatus based on a predetermined condition.

In the input apparatus according to the embodiment, the first axis is a pitch axis, the second axis is a yaw axis, and the third axis a roll axis. Thus, when a horizontally long screen is used, for example, the user is capable of readily moving the UI in the horizontal direction. Further, operations that match an intuition of the user become possible since the user is capable of moving the UI horizontally by causing the input apparatus to rotate about the third axis.

In the input apparatus according to the embodiment, the angular velocity output means includes an angular velocity sensor configured to detect the first angular velocity, the second angular velocity, and the third angular velocity. In this case, the angular velocity output means includes an angle sensor configured to detect a first angle about the first axis and a third angle about the third axis, an angular velocity sensor configured to detect the second angular velocity, and differentiation means for calculating the first angular velocity and the third angular velocity through differentiation operations of the first angle and the third angle. In this case, the input apparatus may further include rotation correction means. The rotation correction means corrects the first angular velocity and the second angular velocity through rotational coordinate conversion that corresponds to the third angle to obtain a first correction angular velocity and a second correction angular velocity, and outputs information on the first correction angular velocity and the second correction angular velocity. Further, in the input apparatus, the combination calculation means may calculate a second combined angular velocity obtained as a result of combining two angular velocities, which are obtained by respectively multiplying the second correction angular velocity and the third angular velocity by the two migration coefficients, and the output means may output information on the second combined angular velocity and the first correction angular velocity as the input information.

In the input apparatus according to the embodiment, the angular velocity output means includes an angle sensor, an angular velocity sensor, and differentiation means. The angle sensor detects one of a first angle about the first axis and a third angle about the third axis. The angular velocity sensor detects the second angular velocity and the third angular velocity when the first angle is detected by the angle sensor, and detects the first angular velocity and the second angular velocity when the third angle is detected by the angle sensor. The differentiation means calculates the first angular velocity through a differentiation operation of the first angle when the first angle is detected by the angle sensor, and calculates the third angular velocity through a differentiation operation of the third angle when the third angle is detected by the angle sensor. In this case, the input apparatus may further include rotation correction means. The rotation correction means corrects, when the third angle is detected by the angle sensor, the first angular velocity and the second angular velocity by rotational coordinate conversion that corresponds to the third angle to obtain a first correction angular velocity and a second correction angular velocity, and outputs information on the first correction angular velocity and the second correction angular velocity. Further, in the input apparatus, the combination calculation means may calculate a second combined angular velocity obtained as a result of combining two angular velocities, which are obtained by respectively multiplying the second correction angular velocity and the third angular velocity by the two migration coefficients, and the output means may output information on the second combined angular velocity and the first correction angular velocity as the input information. The angular velocity output means may include a triaxial angle sensor for detecting all of the first to third angles.

Examples of the angle sensor include an acceleration sensor, a geomagnetic sensor, and an image sensor.

According to another embodiment, there is provided a control apparatus configured to control a movement of a UI displayed on a screen in accordance with input information output from an input apparatus, the input information being information on a first angular velocity about a first axis, a second angular velocity about a second axis different from the first axis, and a third angular velocity about a third axis perpendicular to both the first axis and the second axis. The control apparatus includes reception means, combination calculation means, and coordinate information generation means. The reception means receives the input information. The combination calculation means calculates a first combined angular velocity obtained as a result of combining two angular velocities, which are obtained by respectively multiplying the received second angular velocity and the received third angular velocity by two migration coefficients represented by a predetermined ratio. The coordinate information generation means generates second coordinate information of the UI in an axial direction on the screen corresponding to the second axis, the second coordinate information corresponding to the received first angular velocity, and generates first coordinate information of the UI in an axial direction on the screen corresponding to the first axis, the first coordinate information corresponding to the first combined angular velocity.

According to another embodiment, there is provided a control apparatus configured to control a movement of a UI displayed on a screen in accordance with input information output from an input apparatus, the input information being information on a first angle about a first axis, a second angle about a second axis different from the first axis, and a third angle about a third axis perpendicular to both the first axis and the second axis. The control apparatus includes reception means, differentiation means, combination calculation means, and coordinate information generation means. The reception means receives the input information. The differentiation means calculates a first angular velocity, a second angular velocity, and a third angular velocity through differentiation operations of the received first angle, the received second angle, and the received third angle, respectively. The combination calculation means calculates a first combined angular velocity obtained as a result of combining two angular velocities, which are obtained by respectively multiplying the second angular velocity and the third angular velocity by two migration coefficients represented by a predetermined ratio. The coordinate information generation means generates second coordinate information of the UI in an axial direction on the screen corresponding to the second axis, the second coordinate information corresponding to the first angular velocity, and generates first coordinate information of the UI in an axial direction on the screen corresponding to the first axis, the first coordinate information corresponding to the first combined angular velocity.

According to another embodiment, there is provided a control system including an input apparatus and a control apparatus. The input apparatus includes angular velocity output means for outputting a first angular velocity about a first axis, a second angular velocity about a second axis different from the first axis, and a third angular velocity about a third axis perpendicular to both the first axis and the second axis, combination calculation means for calculating a first combined angular velocity obtained as a result of combining two angular velocities, which are obtained by respectively multiplying the second angular velocity and the third angular velocity by two migration coefficients represented by a predetermined ratio, and output means for outputting, as input information, information on the first angular velocity and information on the first combined angular velocity. The control apparatus includes reception means for receiving the input information, and coordinate information generation means for generating second coordinate information of a UI displayed on a screen in an axial direction on the screen corresponding to the second axis, the second coordinate information corresponding to the received first angular velocity, and generating first coordinate information of the UI in an axial direction on the screen corresponding to the first axis, the first coordinate information corresponding to the first combined angular velocity.

According to another embodiment, there is provided a control system including an input apparatus and a control apparatus. The input apparatus includes angular velocity output means for outputting a first angular velocity about a first axis, a second angular velocity about a second axis different from the first axis, and a third angular velocity about a third axis perpendicular to both the first axis and the second axis, and output means for outputting information on the first angular velocity, the second angular velocity, and the third angular velocity as input information. The control apparatus includes reception means for receiving the input information, combination calculation means for calculating a first combined angular velocity obtained as a result of combining two angular velocities, which are obtained by respectively multiplying the received second angular velocity and the received third angular velocity by two migration coefficients represented by a predetermined ratio, and coordinate information generation means for generating second coordinate information of a UI displayed on a screen in an axial direction on the screen corresponding to the second axis, the second coordinate information corresponding to the received first angular velocity, and generating first coordinate information of the UI in an axial direction on the screen corresponding to the first axis, the first coordinate information corresponding to the first combined angular velocity.

According to another embodiment, there is provided a method of controlling a UI on a screen in accordance with a movement of an input apparatus. The method includes: detecting a first angular velocity of the input apparatus about a first axis; detecting a second angular velocity of the input apparatus about a second axis different from the first axis; detecting a third angular velocity of the input apparatus about a third axis perpendicular to both the first axis and the second axis; calculating a first combined angular velocity obtained as a result of combining two angular velocities, which are obtained by respectively multiplying the second angular velocity and the third angular velocity by two migration coefficients represented by a predetermined ratio; generating second coordinate information of the UI in an axial direction on the screen corresponding to the second direction, the second coordinate information corresponding to the first angular velocity; and generating first coordinate information of the UI in an axial direction on the screen corresponding to the first axis, the first coordinate information corresponding to the first combined angular velocity.

According to another embodiment, there is provided an input apparatus configured to output input information for controlling a movement of a UI displayed on a screen, including a first acceleration sensor, a second acceleration sensor, a first angular velocity sensor, a second angular velocity sensor, angle calculation means, angular velocity calculation means, rotation correction means, combination calculation means, and output means. The first acceleration sensor detects a first acceleration in a direction along a first axis. The second acceleration sensor detects a second acceleration in a direction along a second axis different from the first axis. The first angular velocity sensor detects a first angular velocity about the first axis. The second angular velocity sensor detects a second angular velocity about the second axis. The angle calculation means calculates, based on the first acceleration and the second acceleration, an angle about a third axis perpendicular to both the first axis and the second axis, the angle being an angle formed between a combined acceleration vector of the first acceleration and the second acceleration and the second axis. The angular velocity calculation means calculates a third angular velocity about the third axis based on the calculated angle. The rotation correction means corrects the first angular velocity and the second angular velocity by rotational coordinate conversion that corresponds to the calculated angle to obtain a first correction angular velocity and a second correction angular velocity, and outputs information on the first correction angular velocity and the second correction angular velocity. The combination calculation means calculates a combined angular velocity obtained as a result of combining two angular velocities, which are obtained by respectively multiplying the second correction angular velocity and the third angular velocity by two migration coefficients represented by a predetermined ratio. The output means outputs, as the input information, information on the first correction angular velocity for controlling a movement of the UI on the screen in an axial direction corresponding to the second axis and information on the combined angular velocity for controlling the movement of the UI on the screen in an axial direction corresponding to the first axis.

The movement of the UI in the first-axis direction is controlled by at least one of an operation of the user of causing the input apparatus to rotate about the third axis and an operation of moving the input apparatus in the first-axis direction, for example. Accordingly, it is possible to reduce a movement amount when the user moves the input apparatus in the first-axis direction and to thus readily move the UI in the first-axis direction. Moreover, in the embodiment, the biaxial acceleration sensors, that is, the first acceleration sensor and the second acceleration sensor, and the biaxial angular velocity sensors, that is, the first angular velocity sensor and the second angular velocity sensor, enable control of the UI. By use of acceleration values respectively detected by the biaxial acceleration sensors, it becomes possible to appropriately display the UI with the input apparatus held at any position.

The axis corresponding to the second axis is an axis substantially parallel to the second axis in a state where an acceleration detection surface containing the first axis and the second axis is close to being in parallel with the screen, that is, a state where the input apparatus is in an ideal initial position at which the input apparatus is not tilted about the third axis. The same holds true for the axis corresponding to the first axis.

According to another embodiment, there is provided a control apparatus configured to control a movement of a UI displayed on a screen in accordance with input information output by an input apparatus including a first acceleration sensor configured to detect a first acceleration in a direction along a first axis, a second acceleration sensor configured to detect a second acceleration in a direction along a second axis different from the first axis, a first angular velocity sensor configured to detect a first angular velocity about the first axis, and a second angular velocity sensor configured to detect a second angular velocity about the second axis, the input information being information on the first acceleration, the second acceleration, the first angular velocity, and the second angular velocity. The control apparatus includes reception means, angle calculation means, angular velocity calculation means, rotation correction means, combination calculation means, and coordinate information generation means. The reception means receives the input information. The angle calculation means calculates, based on the first acceleration and the second acceleration, an angle about a third axis perpendicular to both the first axis and the second axis, the angle being an angle formed between a combined acceleration vector of the received first acceleration and the received second acceleration and the second axis. The angular velocity calculation means calculates a third angular velocity about the third axis based on the calculated angle. The rotation correction means corrects the received first angular velocity and the received second angular velocity by rotational coordinate conversion that corresponds to the calculated angle to obtain a first correction angular velocity and a second correction angular velocity, and outputs information on the first correction angular velocity and the second correction angular velocity. The combination calculation means calculates a combined angular velocity obtained as a result of combining two angular velocities, which are obtained by respectively multiplying the second correction angular velocity and the third angular velocity by two migration coefficients represented by a predetermined ratio. The coordinate information generation means generates second coordinate information of the UI in an axial direction on the screen corresponding to the second axis, the second coordinate information corresponding to the received first correction angular velocity, and generates first coordinate information of the UI in an axial direction on the screen corresponding to the first axis, the first coordinate information corresponding to the combined angular velocity.

According to another embodiment, there is provided a method of controlling a UI on a screen in accordance with a movement of an input apparatus, including: detecting a first acceleration of the input apparatus in a direction along a first axis; detecting a second acceleration of the input apparatus in a direction along a second axis different from the first axis; detecting a first angular velocity of the input apparatus about the first axis; detecting a second angular velocity of the input apparatus about the second axis; calculating, based on the first acceleration and the second acceleration, an angle about a third axis perpendicular to both the first axis and the second axis, the angle being an angle formed between a combined acceleration vector of the first acceleration and the second acceleration and the second axis; calculating a third angular velocity about the third axis based on the calculated angle; correcting the first angular velocity and the second angular velocity by rotational coordinate conversion that corresponds to the calculated angle to obtain a first correction angular velocity and a second correction angular velocity; outputting information on the first correction angular velocity and the second correction angular velocity; calculating a combined angular velocity obtained as a result of combining two angular velocities, which are obtained by respectively multiplying the second correction angular velocity and the third angular velocity by two migration coefficients represented by a predetermined ratio; generating second coordinate information of the UI in an axial direction on the screen corresponding to the second axis, the second coordinate information corresponding to the first correction angular velocity; and generating first coordinate information of the UI in an axial direction on the screen corresponding to the first axis, the first coordinate information corresponding to the combined angular velocity.

According to another embodiment, there is provided an input apparatus configured to output input information for controlling a movement of a UI displayed on a screen, including an angular velocity output unit, a combination calculation unit, and an output unit. The angular velocity output unit outputs a first angular velocity about a first axis, a second angular velocity about a second axis different from the first axis, and a third angular velocity about a third axis perpendicular to both the first axis and the second axis. The combination calculation unit calculates a first combined angular velocity obtained as a result of combining two angular velocities, which are obtained by respectively multiplying the second angular velocity and the third angular velocity by two migration coefficients represented by a predetermined ratio. The output unit outputs, as the input information, information on the first angular velocity for controlling a movement of the UI in an axial direction on the screen corresponding to the second axis and information on the first combined angular velocity for controlling the movement of the UI in an axial direction on the screen corresponding to the first axis.

According to another embodiment, there is provided a control apparatus configured to control a movement of a UI displayed on a screen in accordance with input information output from a input apparatus, the input information being information on a first angular velocity about a first axis, a second angular velocity about a second axis different from the first axis, and a third angular velocity about a third axis perpendicular to both the first axis and the second axis. The control apparatus includes a reception unit, a combination calculation unit, and a coordinate information generation unit. The reception unit receives the input information. The combination calculation unit calculates a first combined angular velocity obtained as a result of combining two angular velocities, which are obtained by respectively multiplying the received second angular velocity and the received third angular velocity by two migration coefficients represented by a predetermined ratio. The coordinate information generation unit generates second coordinate information of the UI in an axial direction on the screen corresponding to the second axis, the second coordinate information corresponding to the received first angular velocity, and generates first coordinate information of the UI in an axial direction on the screen corresponding to the first axis, the first coordinate information corresponding to the first combined angular velocity.

According to another embodiment, there is provided a control apparatus configured to control a movement of a UI displayed on a screen in accordance with input information output from an input apparatus, the input information being information on a first angle about a first axis, a second angle about a second axis different from the first axis, and a third angle about a third axis perpendicular to both the first axis and the second axis. The control apparatus includes a reception unit, a differentiation unit, a combination calculation unit, and a coordinate information generation unit. The reception unit receives the input information. The differentiation unit calculates a first angular velocity, a second angular velocity, and a third angular velocity through differentiation operations of the received first angle, the received second angle, and the received third angle, respectively. The combination calculation unit calculates a first combined angular velocity obtained as a result of combining two angular velocities, which are obtained by respectively multiplying the second angular velocity and the third angular velocity by two migration coefficients represented by a predetermined ratio. The coordinate information generation unit generates second coordinate information of the UI in an axial direction on the screen corresponding to the second axis, the second coordinate information corresponding to the first angular velocity, and generates first coordinate information of the UI in an axial direction on the screen corresponding to the first axis, the first coordinate information corresponding to the first combined angular velocity.

According to another embodiment, there is provided a control system including an input apparatus and a control apparatus. The input apparatus includes an angular velocity output unit configured to output a first angular velocity about a first axis, a second angular velocity about a second axis different from the first axis, and a third angular velocity about a third axis perpendicular to both the first axis and the second axis, a combination calculation unit configured to calculate a first combined angular velocity obtained as a result of combining two angular velocities, which are obtained by respectively multiplying the second angular velocity and the third angular velocity by two migration coefficients represented by a predetermined ratio, and an output unit configured to output, as input information, information on the first angular velocity and information on the first combined angular velocity. The control apparatus includes a reception unit configured to receive the input information, and a coordinate information generation unit configured to generate second coordinate information of a UI displayed on a screen in an axial direction on the screen corresponding to the second axis, the second coordinate information corresponding to the received first angular velocity, and generate first coordinate information of the UI in an axial direction on the screen corresponding to the first axis, the first coordinate information corresponding to the first combined angular velocity.

According to another embodiment, there is provided a control system including an input apparatus and a control apparatus. The input apparatus includes an angular velocity output unit configured to output a first angular velocity about a first axis, a second angular velocity about a second axis different from the first axis, and a third angular velocity about a third axis perpendicular to both the first axis and the second axis, and an output unit configured to output information on the first angular velocity, the second angular velocity, and the third angular velocity as input information. The control apparatus includes a reception unit configured to receive the input information, a combination calculation unit configured to calculate a first combined angular velocity obtained as a result of combining two angular velocities, which are obtained by respectively multiplying the received second angular velocity and the received third angular velocity by two migration coefficients represented by a predetermined ratio, and a coordinate information generation unit configured to generate second coordinate information of a UI displayed on a screen in an axial direction on the screen corresponding to the second axis, the second coordinate information corresponding to the received first angular velocity, and generate first coordinate information of the UI in an axial direction on the screen corresponding to the first axis, the first coordinate information corresponding to the first combined angular velocity.

According to another embodiment, there is provided a control apparatus configured to control a movement of a UI displayed on a screen in accordance with input information output by an input apparatus including a first acceleration sensor configured to detect a first acceleration in a direction along a first axis, a second acceleration sensor configured to detect a second acceleration in a direction along a second axis different from the first axis, a first angular velocity sensor configured to detect a first angular velocity about the first axis, and a second angular velocity sensor configured to detect a second angular velocity about the second axis, the input information being information on the first acceleration, the second acceleration, the first angular velocity, and the second angular velocity. The control apparatus includes a reception unit, an angle calculation unit, an angular velocity calculation unit, a rotation correction unit, a combination calculation unit, and a coordinate information generation unit. The reception unit receives the input information. The angle calculation unit calculates, based on the first acceleration and the second acceleration, an angle about a third axis perpendicular to both the first axis and the second axis, the angle being an angle formed between a combined acceleration vector of the received first acceleration and the received second acceleration and the second axis. The angular velocity calculation unit calculates a third angular velocity about the third axis based on the calculated angle. The rotation correction unit corrects the received first angular velocity and the received second angular velocity by rotational coordinate conversion that corresponds to the calculated angle to obtain a first correction angular velocity and a second correction angular velocity, and outputs information on the first correction angular velocity and the second correction angular velocity. The combination calculation unit calculates a combined angular velocity obtained as a result of combining two angular velocities, which are obtained by respectively multiplying the second correction angular velocity and the third angular velocity by two migration coefficients represented by a predetermined ratio. The coordinate information generation unit generates second coordinate information of the UI in an axial direction on the screen corresponding to the second axis, the second coordinate information corresponding to the received first correction angular velocity, and generates first coordinate information of the UI in an axial direction on the screen corresponding to the first axis, the first coordinate information corresponding to the combined angular velocity.

As described above, according to the embodiments, it is possible to readily move the UI in a predetermined direction in accordance with a shape of the screen on the display.

In the descriptions above, elements described as “ . . . means” may be realized by hardware or by both software and hardware. When realizing those elements by both the software and hardware, the hardware includes at least a storage device for storing a software program.

Typically, the hardware is structured by selectively using at least one of a CPU (Central Processing Unit), an MPU (Micro Processing Unit), a RAM (Random Access Memory), a ROM (Read Only Memory), a DSP (Digital Signal Processor), an FPGA (Field Programmable Gate Array), an ASIC (Application Specific Integrated Circuit), an NIC (Network Interface Card), a WNIC (Wireless NIC), a modem, an optical disk, a magnetic disk, and a flash memory.

Additional features and advantages are described herein, and will be apparent from the following Detailed Description and the figures.

### BRIEF DESCRIPTION OF THE FIGURES

FIG. 1 is a diagram showing a control system according to an embodiment;

FIG. 2 is a perspective view showing an input apparatus;

FIG. 3 is diagram schematically showing an internal structure of the input apparatus;

FIG. 4 is a block diagram showing an electrical structure of the input apparatus;

FIG. 5 is a diagram showing an example of a screen displayed on a display apparatus;

FIG. 6 is a view showing a state where a user is holding the input apparatus;

FIGS. 7 are explanatory diagrams showing typical examples of ways of moving the input apparatus;

FIG. 8 is a perspective view showing a sensor unit;

FIG. 9 is a flowchart showing an operation of the control system;

FIG. 10 is a flowchart showing an operation of a control system according to another embodiment;

FIG. 11 are diagrams for illustrating a gravitational effect with respect to an acceleration sensor unit;

FIG. 12 is a flowchart showing an operation of the control system including correction processing using rotational coordinate conversion in a roll direction for suppressing the gravitational effect with respect to the acceleration sensor as much as possible;

FIG. 13 shows an equation used in the rotational coordinate conversion and an explanatory diagram therefor;

FIG. 14 is a flowchart showing an operation of the control system in a case where the input apparatus is operated while a detection surface thereof is tilted with respect to a vertical plane;

FIG. 15A is a diagram showing the acceleration sensor unit in a state where the input apparatus is held still at a position at which the detection surface thereof is tilted with respect to the vertical plane and is also tilted in a roll direction, and FIG. 15B is a diagram showing the acceleration sensor unit in the state shown in FIG. 15A seen from an absolute X-Z plane;

FIG. 16A is a diagram showing a position of the acceleration sensor unit at an instant when a calculation of a roll angle is stopped, and FIG. 16B is a diagram showing the position of the acceleration sensor unit at an instant when the calculation of the roll angle is resumed;

FIG. 17 is a flowchart showing an operation of processing for reducing calculation errors of a roll angle in FIG. 16;

FIG. 18 is a flowchart showing an operation of the processing for reducing calculation errors of the roll angle according to another embodiment;

FIG. 19 is a block diagram showing an electrical structure of an input apparatus according to another embodiment;

FIG. 20 is a flowchart showing an operation of a control system including the input apparatus shown in FIG. 19;

FIG. 21 is a flowchart showing an operation of the control system including the input apparatus according to another embodiment;

FIG. 22 is a flowchart showing an operation of the control system including the input apparatus shown in FIG. 2 according to another embodiment;

FIG. 23 is a block diagram showing an input apparatus according to a first embodiment, for suppressing fluctuations of a roll angle that are caused when a user operates a UI by actually moving the input apparatus after an effect of a gravity acceleration component generated due to a tilt of the input apparatus in a roll direction has been removed;

FIG. 24A is a graph showing an acceleration signal in an X′- or Y′-axis direction, which has not yet passed through a low-pass filter (LPF), and FIG. 24B is a graph showing the acceleration signal after having passed through the LPF;

FIG. 25 is a flowchart showing an operation for monitoring angular acceleration values in calculating the roll angle according to a second embodiment in which fluctuations of the roll angle are suppressed;

FIG. 26 is a schematic diagram showing a structure of an input apparatus according to another embodiment;

FIG. 27 is a perspective view showing an input apparatus according to another embodiment;

FIG. 28 is a side view of the input apparatus shown in FIG. 27 seen from a rotary button side;

FIG. 29 is a view showing a state where the user operates the input apparatus while a lower curved surface thereof is in contact with a knee of the user;

FIG. 30 is a perspective view showing an input apparatus according to another embodiment;

FIG. 31 is a front view showing an input apparatus according to another embodiment;

FIG. 32 is a side view showing the input apparatus shown in FIG. 31;

FIG. 33 is a front view showing an input apparatus according to another embodiment; and

FIG. 34 are diagrams for illustrating a principle of an angle sensor.

### DETAILED DESCRIPTION

Hereinafter, embodiments will be described with reference to the drawings.

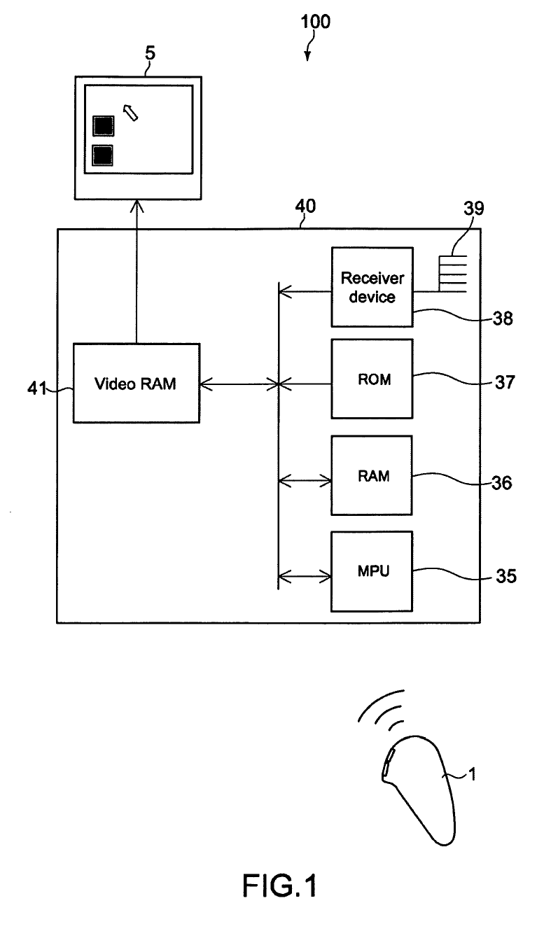

FIG. 1 is a diagram showing a control system according to an embodiment. A control system 100 includes a display apparatus 5, a control apparatus 40, and an input apparatus 1.

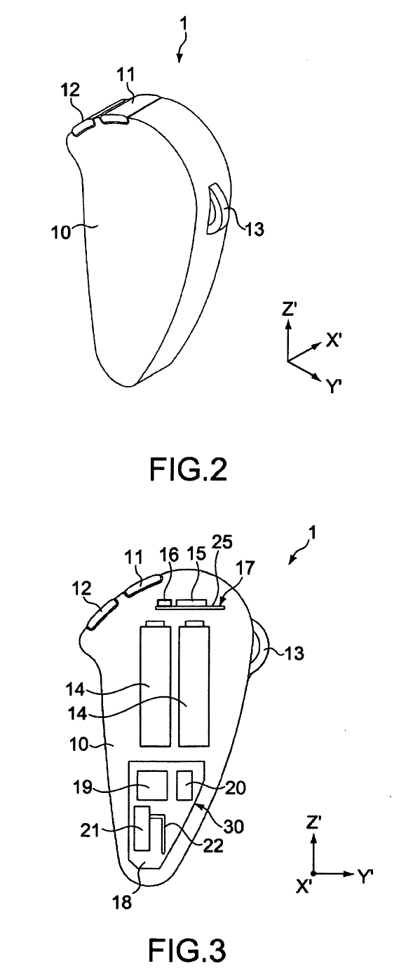

FIG. 2 is a perspective view showing the input apparatus 1. The input apparatus 1 is of a size that a user is capable of holding. The input apparatus 1 includes a casing 10 and operation sections. The operation sections are, for example, two buttons 11 and 12 provided on an upper portion of the casing 10, and a rotary wheel button 13. The button 11 is disposed closer to the center of the upper portion of the casing 10 than the button 12. The button 11 functions as a left button of a mouse, i.e., an input device for a PC. The button 12 is adjacent to the button 11, and functions as a right button of the mouse.

For example, a “drag and drop” operation may be executed by moving the input apparatus 1 while pressing the button 11. A file may be opened by double-clicking the button 11. Further, a screen 3 may be scrolled with the wheel button 13. Locations of the buttons 11 and 12 and the wheel button 13, a content of a command issued, and the like can arbitrarily be changed.

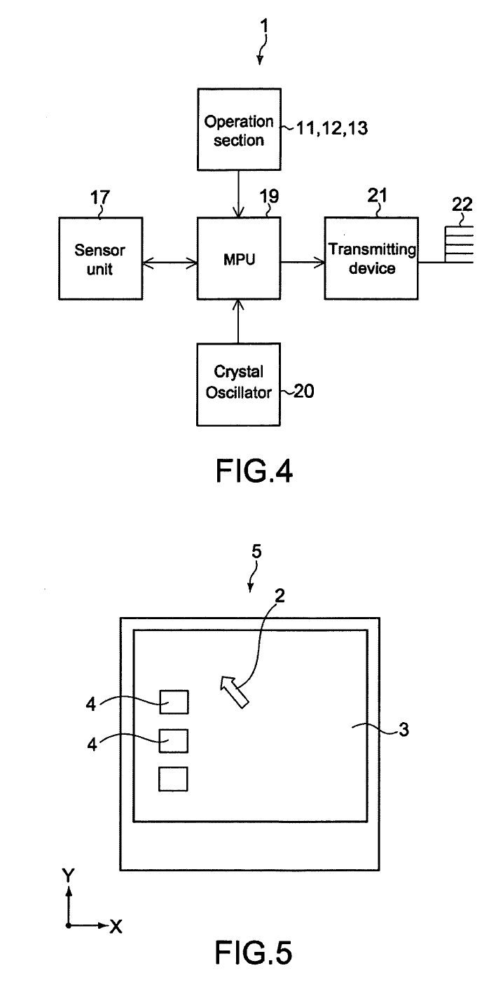

FIG. 3 is a diagram schematically showing an inner structure of the input apparatus 1. FIG. 4 is a block diagram showing an electrical structure of the input apparatus 1.

The input apparatus 1 includes a sensor unit 17, a control unit 30, and batteries 14.

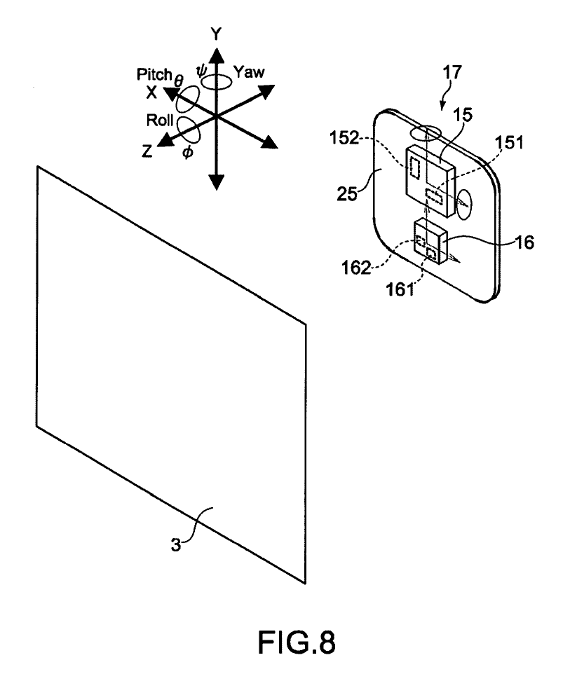

FIG. 8 is a perspective view showing the sensor unit 17. The sensor unit 17 includes an acceleration sensor unit 16. The acceleration sensor unit 16 detects accelerations in different angles, e.g., along two orthogonal axes (X axis and Y axis). That is, the acceleration sensor unit 16 includes two sensors, i.e., a first acceleration sensor 161 and a second acceleration sensor 162. The sensor unit 17 further includes an angular velocity sensor unit 15. The angular velocity sensor unit 15 detects angular accelerations about the two orthogonal axes. That is, the angular velocity sensor unit 15 includes two sensors, i.e., a first angular velocity sensor 151 and a second angular velocity sensor 152. The acceleration sensor unit 16 and the angular velocity sensor unit 15 are respectively packaged and mounted on a circuit board 25.

As each of the first angular velocity sensor 151 and the second angular velocity sensor 152, a vibration gyro sensor for detecting Colioris force in proportion with an angular velocity is used. As each of the first acceleration sensor 161 and the second acceleration sensor 162, any sensor such as a piezoresistive sensor, a piezoelectric sensor, or a capacitance sensor may be used.

In the description made with reference to FIGS. 2 and 3, a longitudinal direction of the casing 10 is referred to as Z′ direction, a thickness direction of the casing 10 is referred to as X′ direction, and a width direction of the casing 10 is referred to as Y′ direction, for convenience. In this case, the sensor unit 17 is incorporated into the casing 10 such that a surface of the circuit board 25 on which the acceleration sensor unit 16 and the angular velocity sensor unit 15 are mounted is substantially in parallel with an X′-Y′ plane. As described above, the acceleration sensor unit 16 and the angular velocity sensor unit 15 each detect physical amounts with respect to the two axes, i.e., the X axis and the Y axis. In addition, a plane including an X′ axis (pitch axis) and a Y′ axis (yaw axis), that is, a plane substantially parallel to a main surface of the circuit board 25, is referred to as acceleration detection surface (hereinafter, will simply be referred to as detection surface). It should be noted that, in the following description, a coordinate system that moves with the input apparatus 1, i.e., the coordinate system fixed to the input apparatus 1, is referred to as the X′ axis, the Y′ axis, and the Z′ axis. On the other hand, in the following description, a geostationary coordinate system on the earth, i.e., the inertial coordinate system, is referred to as the X axis, the Y axis, and the Z axis. In the following description, with regard to a movement of the input apparatus 1, a rotational direction about the X′ axis is sometimes referred to as pitch direction, a rotational direction about the Y′ axis is sometimes referred to as yaw direction, and a rotational direction about the Z′ axis (roll axis) is sometimes referred to as roll direction.

The control unit 30 includes a main substrate 18, an MPU (Micro Processing Unit) 19 (or CPU) mounted on the main substrate 18, a crystal oscillator 20, a transmitting device 21, and an antenna 22 printed on the main substrate 18.

The MPU 19 includes a built-in volatile or nonvolatile memory requisite therefor. A detection signal output from the sensor unit 17, an operation signal output from the operation sections, and other signals are input to the MPU 19. The MPU 19 executes various types of operational processing to generate predetermined control signals in response to those input signals.

The transmitting device 21 transmits control signals (input information) generated in the MPU 19 as RF radio signals to the control apparatus 40 via the antenna 22.

The crystal oscillator 20 generates clocks and supplies the clocks to the MPU 19. As the batteries 14, dry cell batteries, rechargeable batteries, or the like are used.

The control apparatus 40 is a computer, and includes an MPU 35 (or CPU), a RAM 36, a ROM 37, a video RAM 41, an antenna 39, and a receiver device 38.

The receiver device 38 receives the control signal (input information) transmitted from the input apparatus 1 via the antenna 39. The MPU 35 analyzes the control signal and executes various types of operational processing. As a result, a display control signal for controlling a UI displayed on the screen 3 of the display apparatus 5 is generated. The video RAM 41 stores screen data displayed on the display apparatus 5 generated in response to the display control signal.

The control apparatus 40 may be an apparatus dedicated to the input apparatus 1, or may be a PC or the like. The control apparatus 40 is not limited to the PC, and may be a computer integrally formed with the display apparatus 5, an audio/visual device, a projector, a game device, a car navigation device, or the like.

Examples of the display apparatus 5 include a liquid crystal display and an EL (Electro-Luminescence) display, but are not limited thereto. The display apparatus 5 may alternatively be an apparatus integrally formed with a display and capable of receiving television broadcasts and the like.

FIG. 5 is a diagram showing an example of the screen 3 displayed on the display apparatus 5. On the screen 3, UIs such as icons 4 and a pointer 2 are displayed. The icons are images on the screen 3 representing functions of programs, execution commands, file contents, and the like of the computer. It should be noted that, in the screen 3, the horizontal direction is referred to as X-axis direction and the vertical direction is referred to as Y-axis direction. In the following description, in order to facilitate understanding, an operation-target UI to be operated by the input apparatus 1 is assumed to be the pointer 2 (so-called cursor), except when specified otherwise.

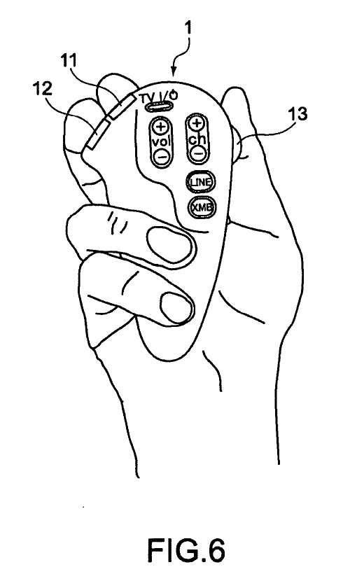

FIG. 6 is a diagram showing a state where a user is holding the input apparatus 1. As shown in FIG. 6, the input apparatus 1 may include operation sections including, in addition to the buttons 11 and 12 and the wheel button 13, various operation buttons such as those provided to a remote controller for operating a television or the like and a power switch, for example. When the user moves the input apparatus 1 in the air or operates the operation sections while holding the input apparatus 1 as shown in the figure, the input information is output to the control apparatus 40, and the control apparatus 40 controls the UI.

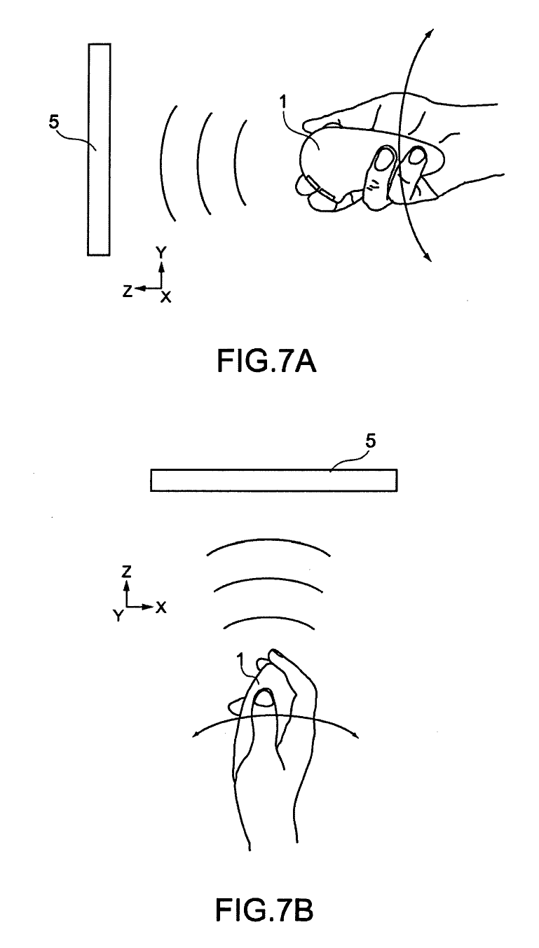

Subsequently, typical examples of ways of moving the input apparatus 1 and the movement of the pointer 2 on the screen 3 in response thereto will be described. FIGS. 7A and 7B are explanatory diagrams therefor.

As shown in FIGS. 7A and 7B, the user holds the input apparatus 1 so as to aim the buttons 11 and 12 side of the input apparatus 1 at the display apparatus 5 side. The user holds the input apparatus 1 such that a thumb is located on an upper side and a little finger is located on a lower side as in handshakes. In this state, the circuit board 25 (see FIG. 8) of the sensor unit 17 is substantially in parallel with the screen 3 of the display apparatus 5. Herein, the two axes being detection axes of the sensor unit 17 correspond to the horizontal axis (X axis) (pitch axis) and the vertical axis (Y axis) (yaw axis) on the screen 3, respectively. Hereinafter, the position of the input apparatus 1 as shown in FIGS. 7A and 7B is referred to as reference position.

As shown in FIG. 7A, when the input apparatus 1 is in the reference position, the user swings a wrist or an arm in the vertical direction or causes the input apparatus 1 to rotate about the X axis. At this time, the second acceleration sensor 162 detects an acceleration (second acceleration) in the Y-axis direction and the first angular velocity sensor 151 detects an angular velocity (first angular velocity) ω_{θ} about the X axis. Based on the detection values, the control apparatus 40 controls the display of the pointer 2 such that the pointer 2 moves in the Y-axis direction.

Meanwhile, as shown in FIG. 7B, when the input apparatus 1 is in the reference position, the user swings the wrist or the arm in the horizontal direction or causes the input apparatus 1 to rotate about the Y axis. At this time, the first acceleration sensor 161 detects an acceleration (first acceleration) in the X-axis direction and the second angular velocity sensor 152 detects an angular velocity (second angular velocity) ω_{ψ} about the Y axis. Based on the detection values, the control apparatus 40 controls the display of the pointer 2 such that the pointer 2 moves in the X-axis direction.

Moreover, in this embodiment, also by the user rotating the input apparatus 1 by twisting the wrist about the Z axis from the reference position, that is, by causing the input apparatus 1 to rotate in the roll direction, the display of the pointer 2 can be controlled to move the pointer 2 in the X-axis direction. Typically, in this embodiment, the display of the pointer 2 is controlled to move the pointer 2 in the X-axis direction by at least one of an operation of moving the input apparatus 1 horizontally and an operation of causing the input apparatus 1 to rotate about the Z-axis.

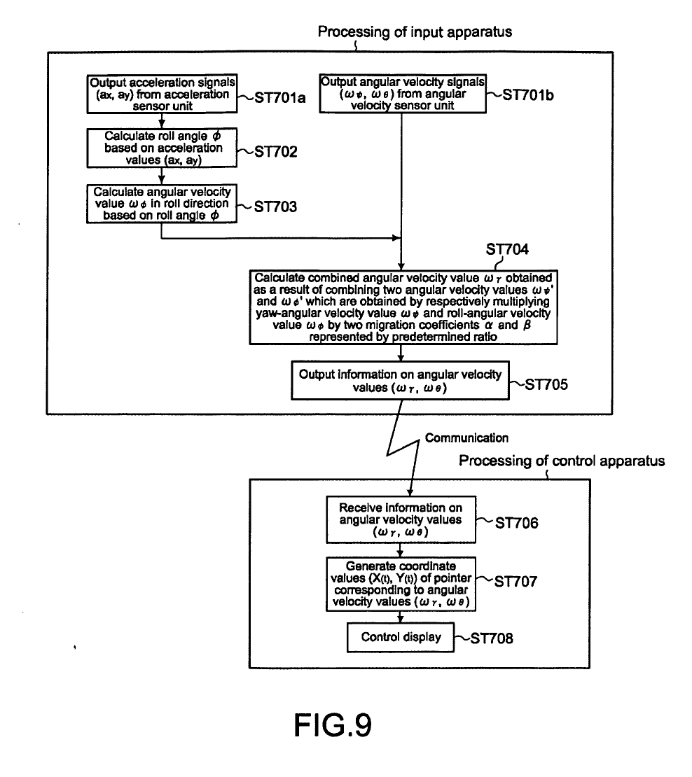

Hereinafter, descriptions will be given on an operation of the control system 100. FIG. 9 is a flowchart showing the operation.

First, power of the input apparatus 1 is turned on. For example, a power switch or the like provided to the input apparatus 1 or the control apparatus 40 is turned on by the user, to thereby turn on the power of the input apparatus 1. Upon turning on the power, the acceleration sensor unit 16 outputs biaxial acceleration signals (first and second acceleration values aₓ and a_{y}) (Step 701a), which are then supplied to the MPU 19. The acceleration signals are signals corresponding to a position of the input apparatus 1 at a time when the power of the input apparatus 1 is turned on (hereinafter, referred to as initial position). Here, the initial position is assumed to be the reference position, which means that aₓ=0 and a_{y}=gravity acceleration. The display of the pointer 2 is controlled by the user moving the input apparatus 1 from this state.

The MPU 19 calculates a roll angle φ using Equation (1) below based on the gravity acceleration component values (aₓ, a_{y}) (Step 702) (angle calculation means), and stores the values in the memory.

φ=arc tan(aₓ/a_{y}) (1)

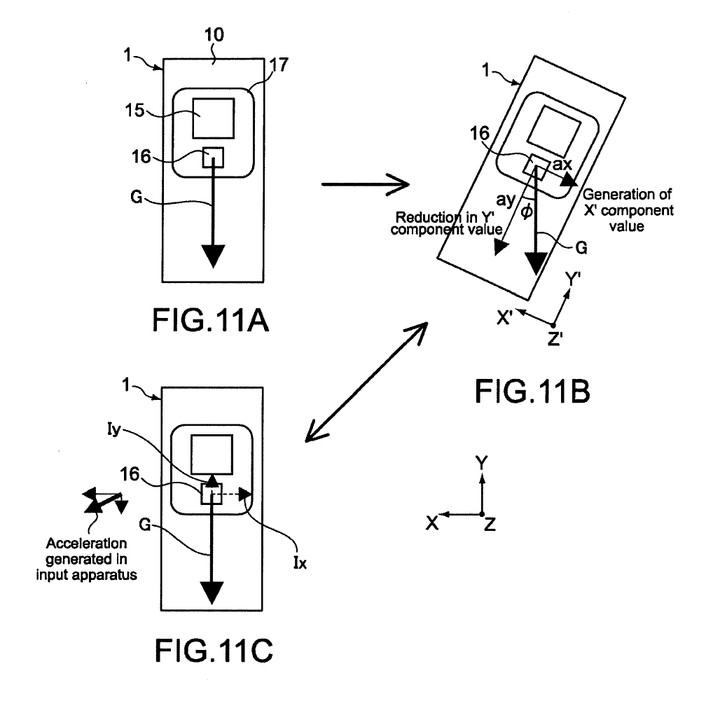

The roll angle used herein refers to an angle formed between a combined acceleration vector with respect to the X′- and Y′-axis directions and the Y′ axis (see FIG. 11B). A coordinate system of the X′ axis, the Y′ axis, and the Z′ axis is a coordinate system that moves in accordance with the movement of the input apparatus. In other words, the coordinate system is stationary with respect to the sensor unit 17. Here, because the initial position is the reference position, φ is 0 in the initial position.

Further, upon turning on the power of the input apparatus 1, biaxial angular velocity signals (first and second angular velocity values ω_{θ} and ω_{ψ}) are output from the angular velocity sensor unit 15 (Step 701b), which are then supplied to the MPU 19.

The MPU 19 calculates the angular velocity (roll-angular velocity) value ω_{φ} in the roll direction based on the roll angle φ calculated in Step 702 (Step 703) (angular velocity calculation means), and stores the value in the memory. The angular velocity value ω_{φ} in the roll direction is obtained through temporal differentiation of the roll angle φ. It is only necessary that the MPU 19 sample a plurality of roll angles φ to perform differentiation, or output the roll angle φ calculated every predetermined number of clocks (i.e., per unit time) as the angular velocity value ω_{φ}.

The MPU 19 respectively multiplies the yaw-angular velocity value (second angular velocity value) ω_{ψ} and the roll-angular velocity value ω_{φ} by migration coefficients α and β represented by a predetermined ratio. The values of α and β are real numbers or functions set arbitrarily, and only need to be stored in a ROM or other storage devices. The input apparatus 1 or the control apparatus 40 may include a program with which the user can set α and β. The MPU 19 calculates a combined angular velocity (first combined angular velocity) value ω_{γ} obtained as a result of combining two angular velocity values ω_{ψ}′ and ω_{φ}′, which are obtained by respectively multiplying the angular velocity values ω_{ψ} and ω_{φ} by the migration coefficients α and β (Step 704) (combination calculation means).

A typical example of a calculation method for the combination is an addition method used in Equation (2).

ω_{γ}=ω_{ψ}′+ω_{φ}′(=αω_{ψ}+βω_{φ}) (2)

The calculation method for the combination is not limited to Equation (2), and ω_{ψ}′*ω_{φ}′, [(ω_{ψ}′)²+(ω_{φ}′)²]^{1/2}, or any other calculation method may be applied.

The combined angular velocity value ω_{γ} becomes a displacement amount of the pointer 2 on the screen 3 in the X-axis direction, and the angular velocity value ω_{θ} in the pitch direction becomes the displacement amount of the pointer 2 on the screen 3 in the Y-axis direction. In other words, displacement amounts (dX, dY) of the pointer 2 on the X axis and the Y axis can be expressed by Equations (3) and (4) below.

dX=ω_{ψ}′+ω_{φ}′=ω_{γ} (3)

dY=ω_{θ} (4)

The MPU 19 outputs information on the angular velocity values (ω_{γ}, ω_{θ}) to the control apparatus 40 as input information (Step 705) (output means).

The MPU 35 of the control apparatus 40 receives the information on the angular velocity values (ω_{γ}, ω_{θ}) (Step 706). Because the input apparatus 1 outputs the angular velocity values (ω_{γ}, ω_{θ}) every predetermined number of clocks, that is, per unit time, the control apparatus 40 can obtain change amounts of a yaw angle and a pitch angle per unit time after receiving the angular velocity values (ω_{γ}, ω_{θ}). The MPU 35 generates coordinate values of the pointer 2 on the screen 3, which correspond to the obtained change amounts of the yaw angle ψ(t) and the pitch angle θ(t) per unit time (Step 707) (coordinate information generation means). After that, the MPU 35 controls display so that the pointer 2 moves on the screen 3 (Step 708).

In Step 707, the MPU 35 calculates the displacement amounts of the pointer 2 on the screen 3 per unit time that correspond to the displacement amounts of the yaw angle and the pitch angle per unit time by calculation or by using a reference table stored in the ROM 37 in advance. Alternatively, the MPU 35 may output the angular velocity values (ω_{γ}, ω_{θ}) by applying a low-pass filter (may either be digital or analog) on the signals of the angular velocity values (ω_{γ}, ω_{θ}). The MPU 35 can generate the coordinate values of the pointer 2 as described above.

Thus, a movement of the UI in the X-axis direction is controlled with at least one of an operation of the user of causing the input apparatus 1 to rotate about the Z axis and an operation of moving the input apparatus 1 in the X-axis direction, for example. Accordingly, it is possible to reduce a movement amount when the user moves the input apparatus in the X-axis direction and to thus readily move the UI in the X-axis direction.

In particular, when a horizontally long screen is used, for example, the user is capable of readily moving the pointer 2 in the horizontal direction. Further, operations that match an intuition of the user become possible since the user is capable of moving the IU horizontally by causing the input apparatus 1 to rotate about the Z axis.

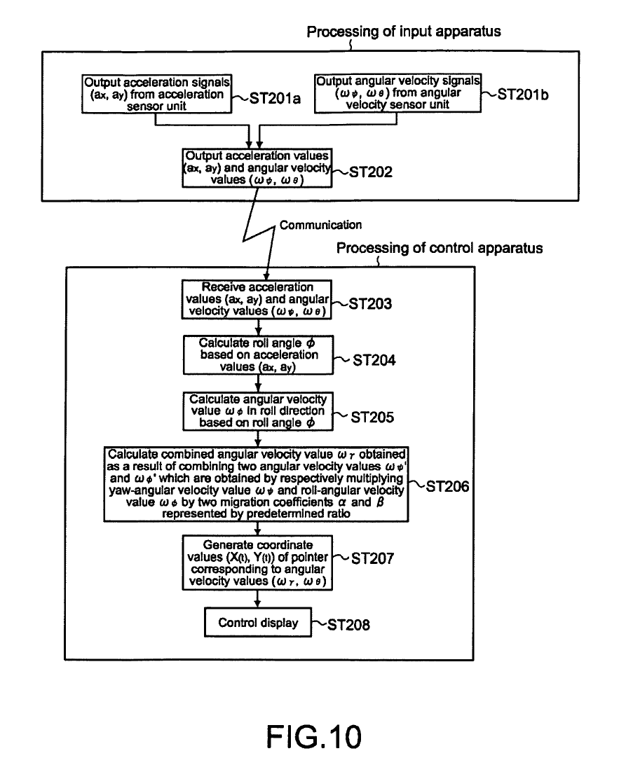

FIG. 10 is a flowchart showing an operation of the control system 100 according to another embodiment.

The flowchart of FIG. 10 is different from that of FIG. 9 in that, in FIG. 9, the input apparatus 1 calculates the combined angular velocity by using the migration coefficients, whereas in FIG. 10, the control apparatus 40 calculates the operational angular velocity values to thus calculate the combined angular velocity.

For example, the MPU 19 of the input apparatus 1 outputs information on the gravity acceleration component values (aₓ, a_{y}) obtained by the acceleration sensor unit 16 and information on the angular velocity values (ω_{ψ}, ω_{θ}) obtained by the angular velocity sensor unit 15 as input information (Step 202).

The MPU 35 of the control apparatus 40 receives the information on the gravity acceleration component values (aₓ, a_{y}) and the information on the angular velocity values (ω_{ψ}, ω_{θ}) (Step 203). Then, the MPU 35 calculates the roll angle φ based on the gravity acceleration component values (aₓ, a_{y}) (Step 204). Similar to Step 703, the MPU 35 calculates the angular velocity value ω_{φ} in the roll direction based on the roll angle φ (Step 205). Then, the MPU 35 obtains the two angular velocity values ω_{ψ}′ and ω_{φ}′ by respectively multiplying the yaw-angular velocity value ω_{ψ}, and the roll-angular velocity value ω_{φ} by the migration coefficients α and β using Equation (2), to thereby calculate the combined angular velocity value ω_{γ} obtained as a result of combining the angular velocity values ω_{ψ}′ and ω_{φ}′ (Step 206). After that, the MPU 35 performs processing similar to that of Steps 707 and 708 shown in FIG. 9 (Steps 207 and 208).

As described above, the operation in which the input apparatus 1 transmits information on the detection values contained in the detection signals for the control apparatus 40 to carry out the operational processing is also possible.

Next, a description will be given on a gravitational effect with respect to the acceleration sensor unit 16. FIG. 11 are explanatory diagrams for illustrating the gravitational effect. In the figures, the input apparatus 1 is seen in the Z-axis direction.

In FIG. 11A, the input apparatus 1 is held still at the reference position. At this time, an output of the first acceleration sensor 161 is substantially 0, and an output of the second acceleration sensor 162 corresponds to an amount of a gravity acceleration G. However, when the input apparatus 1 is tilted in the roll direction as shown in FIG. 11B, for example, the first acceleration sensor 161 and the second acceleration sensor 162 detect acceleration values of tilt components of the gravity acceleration G in the respective directions.

In this case, the first acceleration sensor 161 detects the acceleration in the X-axis direction even when the input apparatus 1 is not actually moved in the yaw direction in particular. The state shown in FIG. 11B is equivalent to a state where, when the input apparatus 1 is in the reference position as shown in FIG. 11C, the acceleration sensor unit 16 has received inertial forces Ix and Iy as respectively indicated by arrows with broken lines, the states shown in FIGS. 11B and 11C being undistinguishable by the acceleration sensor unit 16. As a result, the acceleration sensor unit 16 judges that an acceleration in a downward left-hand direction as indicated by an arrow F has been applied to the input apparatus 1 and outputs a detection signal different from the actual movement of the input apparatus 1. In addition, because the gravity acceleration G constantly acts on the acceleration sensor unit 16, an integration value is increased and an amount by which the pointer 2 is displaced in the downward oblique direction is increased at an accelerating pace. When the state is shifted from that shown in FIG. 11A to that shown in FIG. 11B, it is considered that inhibition of the movement of the pointer 2 on the screen 3 is an operation that intrinsically matches the intuition of the user.

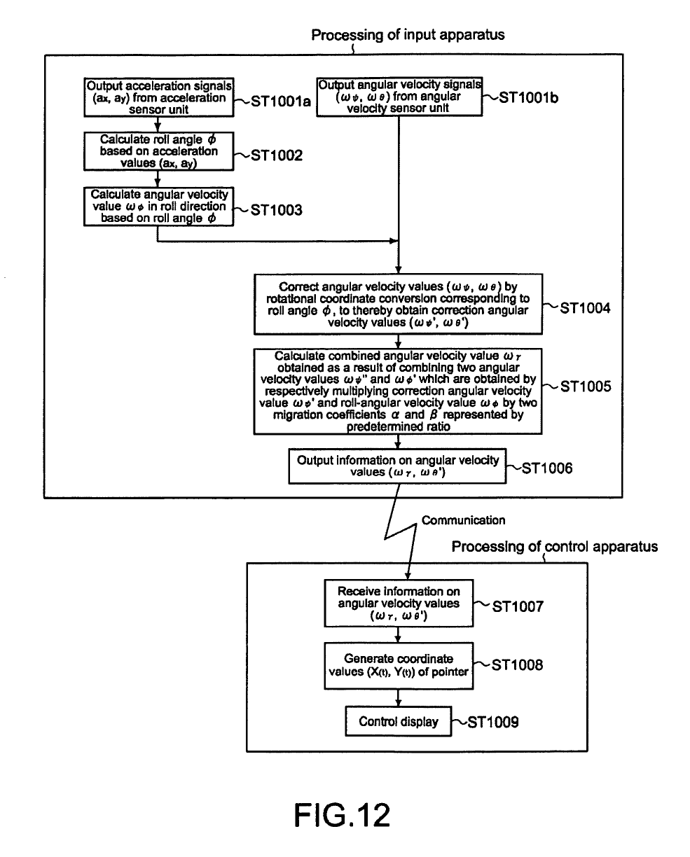

To reduce the gravitational effect with respect to the acceleration sensor unit 16 as described above as much as possible, in a subsequent embodiment, the input apparatus 1 calculates the angular velocity in the roll direction and uses the calculated angular velocity to correct first and second angular velocities. FIG. 12 is a flowchart showing an operation of the control system 100 as described above.

Upon turning on the power of the input apparatus 1, biaxial acceleration signals (first and second acceleration values aₓ and a_{y}) are output from the acceleration sensor unit 16 (Step 1001a), which are then supplied to the MPU 19. In the above embodiment, the initial position has been the reference position. However, in this embodiment, the initial position is a position tilted toward the roll direction as shown in FIG. 11B.

The MPU 19 calculates the roll angle φ using Equation (1) based on the gravity acceleration component values (aₓ, a_{y}) (Step 1002), and stores the values in the memory.

In addition, upon turning on the power of the input apparatus 1, biaxial angular velocity signals (first and second angular velocity values (ω_{θ}and ω_{ψ}) are output from the angular velocity sensor unit 15 (Step 1001b), which are then supplied to the MPU 19. The MPU 19 calculates the angular velocity value ω_{φ} in the roll direction (roll-angular velocity value) in the same manner as in Step 703 based on the roll angle φ calculated in Step 1002 (Step 1003), and stores the value in the memory.

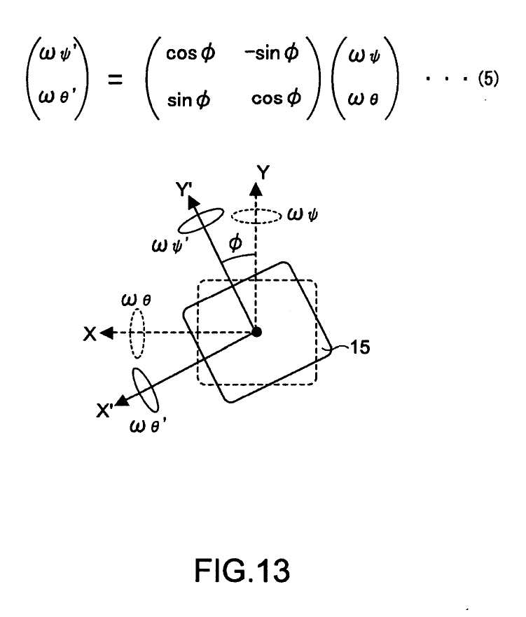

Here, to remove the gravitational effect described with reference to FIG. 11, the MPU 19 corrects the yaw-angular velocity value ω_{ψ} and the pitch-angular velocity value ω₇₄ by rotational coordinate conversion corresponding to the roll angle φ expressed in Equation (5) shown in FIG. 13, for example (Step 1004) (rotation correction means). The MPU 19 thus obtains the angular velocity values (ω_{ψ}′, ω_{θ}′) by the correction, and stores the values in the memory.

The MPU 19 respectively multiplies the correction angular velocity value ω_{ψ}′ and the angular velocity value ω_{φ} in the roll direction calculated in Step 1003 by the migration coefficients α and β represented by a predetermined ratio. Then, the MPU 19 calculates the combined angular velocity (second combined angular velocity) value ω_{γ} obtained as a result of combining two angular velocity values ω_{ψ}″ and ω_{φ}′ which are obtained by the multiplication using the migration coefficients α and β (Step 1005).

The MPU 19 outputs information on the combined angular velocity value ω_{γ} and information on the correction angular velocity value ω_{θ}′ in the pitch direction calculated in Step 1004 as the input information (Step 1006). Then, the control apparatus 40 executes processing similar to that of Steps 706 to 708 (Steps 1007 to 1009).

As described above, in this embodiment, even when the user moves the input apparatus 1 that is in a position tilted with respect to an axis in a gravity direction (hereinafter, referred to as vertical axis) about the Z axis, it is possible to remove an effect of the gravity acceleration components generated in the X′- and Y′-axis directions due to the tilt.

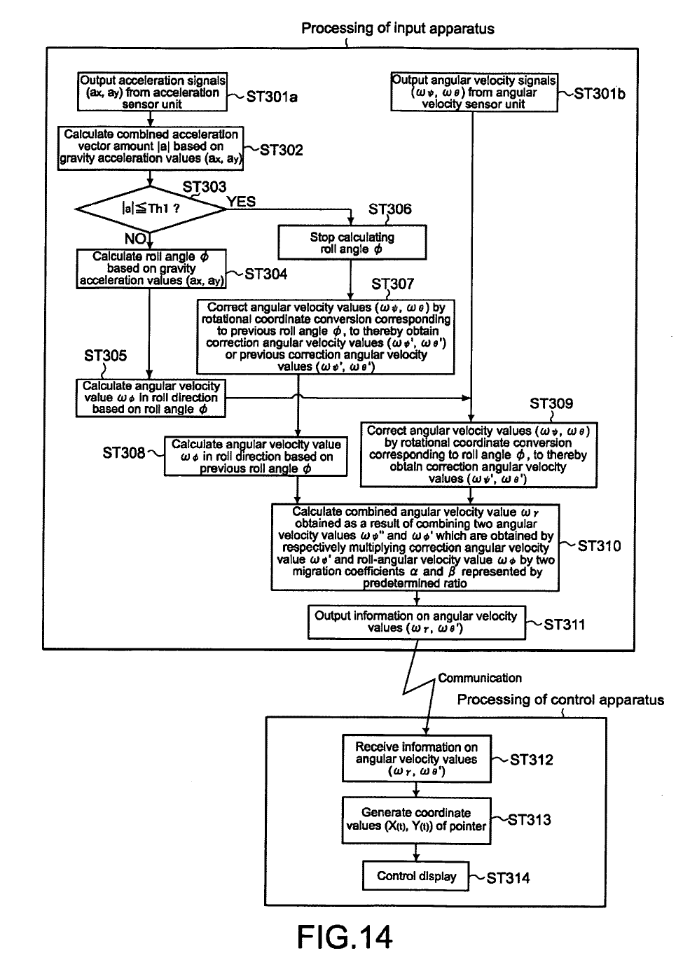

It should be noted that, in the processing of Steps 1001a, 1001b, and the following steps in the second round and after, it is only necessary that the processing of Step 1004 be carried out based on the roll angle φ calculated in the first round in the initial position and stored in the memory. This is because, once the initial position is determined, except for a case where the user intentionally causes the input apparatus 1 to rotate in the roll direction, the fluctuation of the roll angle φ can be assumed to be substantially zero. The same holds true in FIGS. 14, 17, and 18 to be described later.

The processing of Steps 1002 to 1005 of FIG. 12 may be executed by the control apparatus 40 as in FIG. 10.

The above description has illustrated a case where the user operates the input apparatus 1 tilted in the roll direction in a state where the detection surface of the sensor unit 17 is substantially parallel to an absolute vertical surface including the vertical axis. However, there may be a case where the input apparatus 1 is operated while the detection surface thereof is tilted from the vertical surface. Hereinafter, a description will be given on an operation of the control system 100 in such a case. FIG. 14 is a flowchart showing the operation.

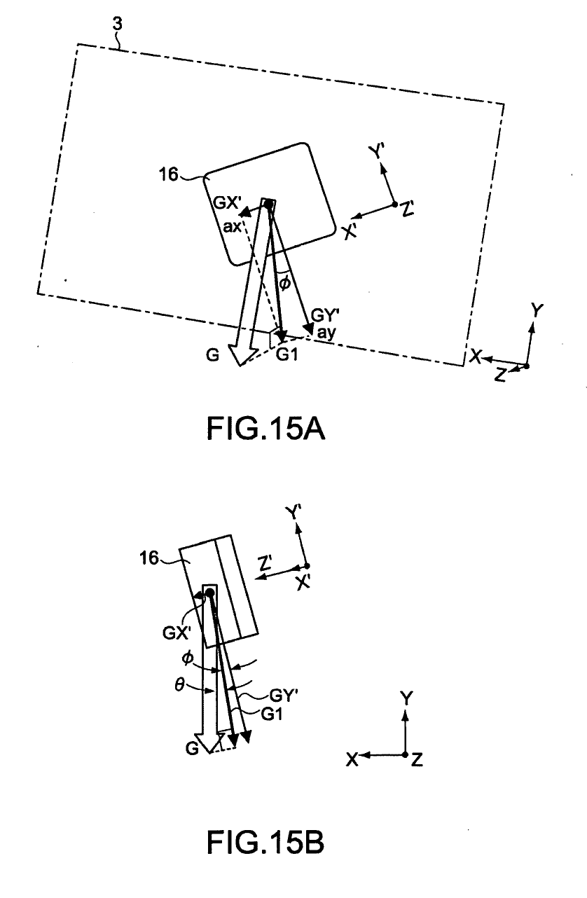

FIG. 15A is a diagram showing the acceleration sensor unit 16 standing still in a state where the detection surface thereof is tilted from the vertical surface and is also tilted in the roll direction. The acceleration sensor unit 16 detects the gravity acceleration component values (aₓ, a_{y}) in the X′- and Y′-axis directions in this state.

In FIG. 15A, the screen 3 substantially parallel to the vertical surface is tilted in the roll direction, and a thick white arrow in the figure represents a gravity acceleration vector G. A vector indicated by an arrow G1 is a combined acceleration vector G1 obtained by combining gravity acceleration vectors (GX′, GY′) in the X′- and Y′-axis directions detected by the acceleration sensor unit 16. Therefore, the combined gravity acceleration vector G1 is a vector of a component of the gravity acceleration vector G rotated in the pitch direction (θ direction). FIG. 15B is a diagram showing the acceleration sensor unit 16 in the state shown in FIG. 15A, which is seen from an absolute X-Z plane.

Referring to FIG. 14, the MPU 19 of the input apparatus 1 obtains the gravity acceleration component values (aₓ, a_{y}) and the angular velocity values (ω_{ψ}, ω_{θ}) output in Steps 301a and 301b. The MPU 19 calculates a combined acceleration vector amount |a| based on the gravity acceleration component values (aₓ, a_{y}) (Step 302). The combined acceleration vector amount |a| can be calculated by [(aₓ)²+(a_{y})²]^{1/2}. The MPU 19 judges whether the calculated combined acceleration vector amount |a| is equal to or smaller than a threshold Th1 (Step 303), and when |a| exceeds the threshold Th1, calculates the roll angle φ (Step 304).

When the tilt of the detection surface from the vertical surface is large, that is, when the pitch angle θ is large, the gravity acceleration component values (aₓ, a_{y}) become smaller and precision of the calculation result of the roll angle φ deteriorates. Therefore, in this embodiment, it becomes difficult to accurately calculate the roll angle φ when the pitch angle θ increases as the roll angle φ calculated based on the gravity acceleration component values (aₓ, a_{y}) is more buried into the noise. Thus, when |a| is equal to or smaller than the threshold Th1, the MPU 19 does not calculate the roll angle, or if the calculation of the roll angle φ is continued until |a| becomes equal to or smaller than the threshold Th1, stops the calculation (Step 306). In this case, the MPU 19 corrects the angular velocity values (ω_{ψ}, ω_{θ}) by rotational coordinate conversion corresponding to the previous roll angle φ, and obtains the correction angular velocity values (ω_{ψ}′, ω_{θ}′) or the previous correction angular velocity values (Step 307). Information on the previous roll angle φ and the previous correction angular velocity values only need to be stored in the RAM or the like. After that, it is only necessary that the MPU 19 calculate the angular velocity value ω_{φ} in the roll direction based on the previous roll angle φ (Step 308), or use the previously-calculated latest angular velocity value ω_{φ}.

The threshold Th1 may be set arbitrarily in consideration of noises and the like.

When the MPU 19 calculates the roll angle φ in Step 304, the MPU 19 calculates the angular velocity value ω_{φ} in the roll direction based on the roll angle φ as in the processing of FIG. 12 (Step 305), and obtains the correction angular velocity values (ω_{ψ}′, ω_{θ}′) by the rotational coordinate conversion corresponding to the roll angle φ (Step 309). Processing of Steps 310 to 314 is the same as that of Steps 1005 to 1009 of FIG. 12.

When the combined acceleration vector amount |a| calculated based on the supplied gravity acceleration component values (aₓ, a_{y}) exceeds the threshold Th1 after the MPU 19 has stopped calculating the roll angle φ in Step 306, the MPU 19 resumes the calculation of the roll angle φ, and the processing of Steps 305, 309, and the subsequent steps is executed.

According to this embodiment, because the MPU 19 stops updating the roll angle φ even when the pitch angle θ is large, the roll angle φ can be calculated accurately.

The processing of Steps 302 to 310 shown in FIG. 14 may be executed by the control apparatus 40 as in FIG. 10.

It should be noted that there is a case where positive/negative of, for example, the second acceleration value a_{y} detected in the Y′-axis direction is switched during a period after the MPU 19 has stopped calculating the roll angle φ in Step 306 to resumption of the calculation.

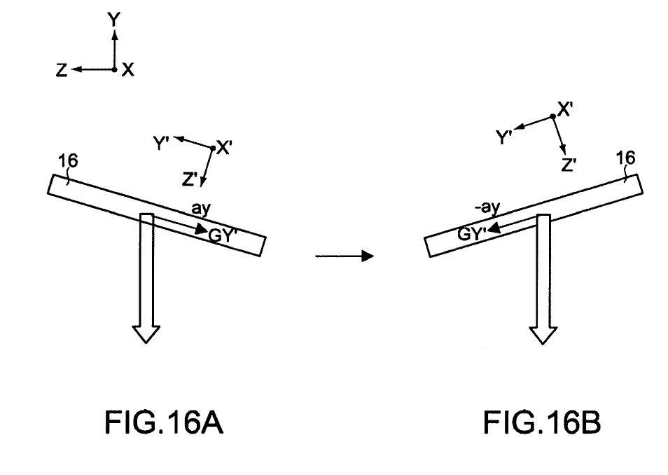

FIGS. 16A and 16B are diagrams illustrating the case described above. FIG. 16A is a diagram showing the position of the acceleration sensor unit 16 at an instant the calculation of the roll angle φ is stopped. FIG. 16B is a diagram showing the position of the acceleration sensor unit 16 at an instant the calculation of the roll angle φ is resumed. In such cases, the positive/negative of the acceleration value a_{y} of the gravity acceleration vector GY′ in the Y′-axis direction is switched. This is not limited to the acceleration in the Y′-axis direction, and the same holds true also in the X′-axis direction. FIGS. 16A and 16B assume a case where, for example, the input apparatus 1 is a pen-type apparatus, and the sensor unit 17 is disposed at a tip end portion of the pen. When the user holds the pen-type input apparatus 1 as if holding a pen, the acceleration sensor unit 16 is positioned such that the detection surface thereof faces downward as shown in FIGS. 16A and 16B.

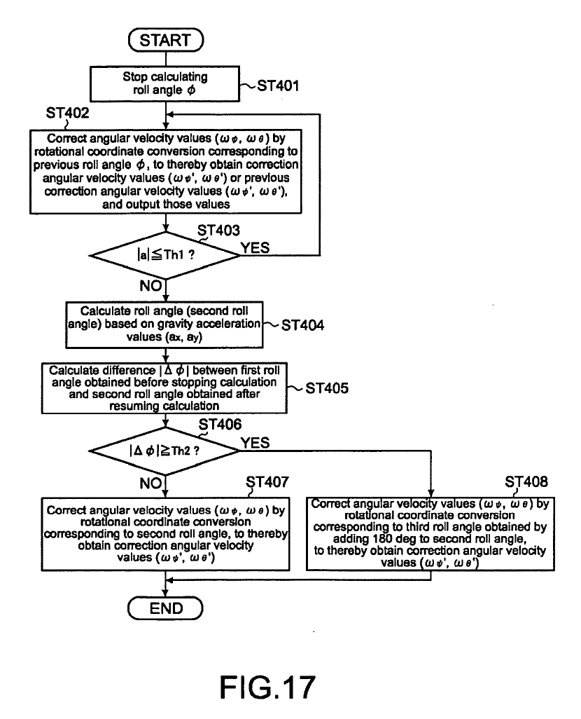

If positive/negative of the acceleration value a_{y} of the gravity acceleration vector GY′ is switched and the acceleration value a_{y} is used as it is, an error is also caused in the calculation of the roll angle φ. FIG. 17 is a flowchart showing an operation of processing executed by the input apparatus 1 for avoiding such a phenomenon from occurring.

Referring to FIG. 17, when it is judged YES in Step 303 (see FIG. 14), the MPU 19 stops calculating the roll angle φ (Step 401). Then, the MPU 19 corrects the angular velocity values (ω_{ψ}, ω_{θ}) by the rotational coordinate conversion corresponding to the previous roll angle φ, to thereby obtain the correction angular velocity values (ω_{ψ}′, ω_{θ}′) or the previous correction angular velocity values, and outputs those values (Step 402). When the supplied combined acceleration vector amount |a| exceeds the threshold Th1 (NO in Step 403), the MPU 19 calculates the roll angle based on the gravity acceleration component values (aₓ, a_{y}) supplied.

Then, the MPU 19 calculates a difference between a roll angle obtained at the time when the calculation of the roll angle φ is stopped, that is, a roll angle calculated just before stopping the calculation (first roll angle) and a roll angle (calculated in Step 404) obtained right after resuming the calculation (second roll angle) (Step 405).

When the difference |Δφ| is equal to or larger than a threshold Th2 (YES in Step 406), the MPU 19 adds 180 deg to the second roll angle that is the latest roll angle. Then, the MPU 19 obtains the correction angular velocity values (ω_{ψ}′, ω_{θ}′) by the rotational coordinate conversion corresponding to a third roll angle obtained by adding 180 deg to the second roll angle (Step 408). When the difference |Δφ| is smaller than the threshold Th2 (NO in Step 406), the MPU 19 obtains the correction angular velocity values (ω_{ψ}′, ω_{θ}′) by the rotational coordinate conversion corresponding to the second roll angle (Step 407). After that, the processing of Step 310 and the subsequent steps in FIG. 14 is executed.

As described above, in this embodiment, precision of the input apparatus 1 in recognizing the position of the input apparatus 1 itself is improved to thus enable display so that the pointer 2 moves in an appropriate direction.

It is possible to set die threshold Th2 within the range of 60 deg (=±30 deg) to 90 deg (=±45 deg), for example, though not limited thereto.

The processing of FIG. 17 may be executed by the control apparatus 40 as in FIG. 10.

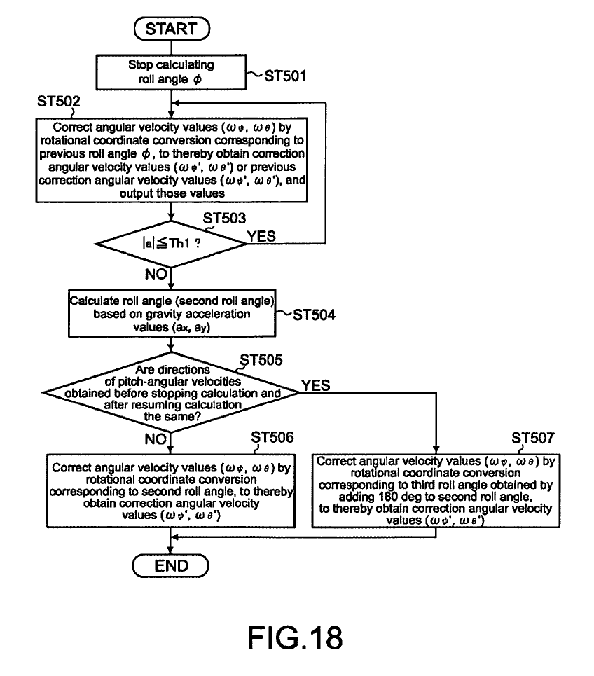

FIG. 18 is a flowchart showing an operation of processing executed by the input apparatus 1 for avoiding the above-mentioned error from occurring, according to another embodiment.

Processing of Steps 501 to 504 is the same as that of Steps 401 to 404 in FIG. 17. The MPU 19 judges whether a direction of the angular velocity ω_{θ} in the pitch direction obtained just before stopping the calculation of the roll angle φ and a direction of the angular velocity ω_{θ} in the pitch direction obtained right after resumption of the calculation are the same (Step 505). In other words, the MPU 19 judges whether positive/negative of ω_{θ} is consistent from before the stop of the calculation of the roll angle φ to after resumption of the calculation. Consistency regarding positive/negative of the angular velocity ω_{ψ} in the yaw direction may be judged instead of or in addition to the angular velocity in the pitch direction.

When it is judged YES in Step 505, it can be judged that the direction of GY′ has changed as shown in FIGS. 16A and 16B since the direction of the angular velocity in the pitch direction is continual. In this case, the MPU 19 obtains the correction angular velocity values (ω_{ψ}′, ω_{θ}′) by the rotational coordinate conversion corresponding to the third roll angle obtained by adding 180 deg to the second roll angle (Step 507). The rest of the processing is the same as that of FIG. 17.

As described above, by recognizing the continuity of the angular velocity ω_{θ} in the pitch direction (or the angular velocity ω_{ψ}′in the yaw direction), precision of the input apparatus 1 in recognizing the position of the input apparatus 1 itself is additionally improved.

The processing of FIG. 18 may be executed by the control apparatus 40 as in FIG. 10.

As another embodiment of the processing shown in FIGS. 17 and 18, judgment may be made on whether a difference between a combined angular velocity vector amount (first combined angular velocity vector amount) as a combination of the first and second angular velocities obtained at the time when the calculation of the roll angle is stopped and the combined angular velocity vector amount (second combined angular velocity vector amount) obtained at the time when the calculation of the roll angle is resumed is equal to or larger than the threshold. The combined angular velocity vector amount can be calculated by [(ω_{ψ})² +(ω_{θ})²]^{1/2}, for example. When the difference between the first combined angular velocity vector amount and the second combined angular velocity vector amount is large, it is judged that the positional change is large. When the difference is judged to be equal to or larger than the threshold, the MPU 19 executes processing similar to that of Steps 408 and 507.

The processing of the input apparatus 1 as described above may also be executed by the control apparatus 40.

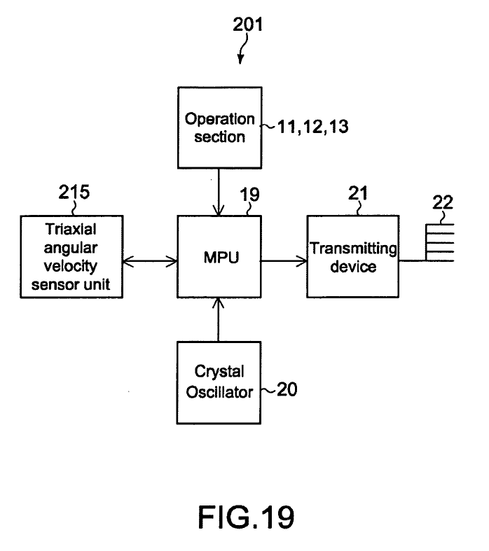

FIG. 19 is a block diagram showing an electrical structure of an input apparatus according to another embodiment. An input apparatus 201 is different from the input apparatus 1 in that the input apparatus 201 includes a triaxial angular velocity sensor unit 215 instead of the sensor unit 17.

The triaxial angular velocity sensor unit 215 includes a first angular velocity sensor for detecting an angular velocity ω_{ψ} about the X′ axis (first angular velocity), a second angular velocity sensor for detecting an angular velocity ω_{θ} about the Y′ axis (second angular velocity), and a third angular velocity sensor for detecting an angular velocity ω_{φ} about the Z′ axis (third angular velocity). Those angular velocity sensors respectively output signals of angular velocity values (ω_{θ}, ω_{ψ}, ω_{φ}).

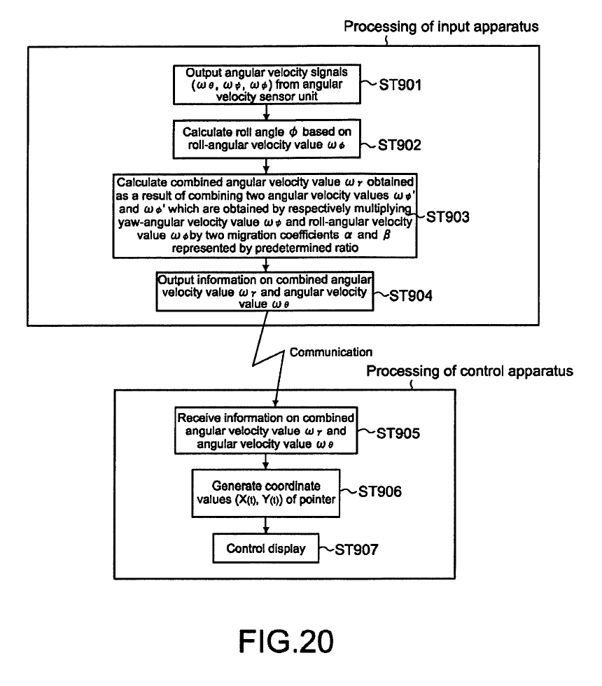

FIG. 20 is a flowchart showing an operation of a control system including the input apparatus 201. The control apparatus 40 employed in the above embodiments may be used as the control apparatus.

Triaxial angular velocity signals are output from the angular velocity sensor unit 215 (Step 901), and the MPU 19 obtains the angular velocity values (ω_{θ}, ω_{ψ}, ω_{φ}). Then, the MPU 19 calculates the roll angle φ by an integration operation using Equation (6) below (Step 902).

φ=φ₀+∫ω_{φ}dt (6)

where φ₀ represents an initial value of the roll angle.

In the above embodiments, the tilt of the input apparatus 1 in the roll direction has been corrected by means of the rotational coordinate conversion. However, in this embodiment, an integration error is caused when no measure is taken when the initial value φ₀ is generated in the initial position of the input apparatus 201.

A simple and practical method of removing integration errors in Equation (6) is exemplified below.

For example, a reset button (not shown) is provided to the input apparatus 201. The reset button is typically a button provided separate from the buttons 11 and 12 and the wheel button 13. While the user is pressing the reset button, the control apparatus 40 controls display so that the pointer 2 moves on the screen in accordance with the operation of the input apparatus 201. Alternatively, from immediately after the user presses the reset button to before the user re-presses the reset button, the control apparatus 40 controls display so that the pointer 2 moves on the screen in accordance with the operation of the input apparatus 201. Specifically, pressing of the reset button is set as a trigger for starting the operation for reducing integration errors.

Here, immediately after the trigger is put into effect, the MPU 19 or the MPU 35 of the control apparatus 40 resets φ₀ and φ to zero (reset means). Alternatively, Equation (6) does not need to include the item of φ₀ in the first place.

In the method described above, practically, integration errors are not spread because φ is reset to zero every time an operation is made using the input apparatus 201 (a time during which the user presses the reset button or a period from immediately after pressing the reset button to re-pressing the button).

In this case, the user needs to be careful to hold the input apparatus 201 at nearly the reference position at the time of pressing the reset button, but difficulty thereof is low and can be easily mastered.

It should be noted that instead of providing the reset button, the MPU 19 of the input apparatus 201 or the MPU 35 of the control apparatus 40 may perform the reset under a predetermined condition. An example of the predetermined condition is a case where the input apparatus 201 is in the reference position. It is only necessary that the acceleration sensor unit 16 or the like be provided to detect that the input apparatus 201 is in the reference position.

After Step 902, the MPU 19 calculates the combined angular velocity value ω_{γ} obtained as a result of combining the two angular velocity values ω_{ψ}′ and ω_{φ}′, which are obtained by respectively multiplying the yaw-angular velocity value ω_{ψ} and the roll-angular velocity value ω_{φ} by the migration coefficients α and β represented by a predetermined ratio (Step 903). The MPU 19 then outputs information on the calculated combined angular velocity value ω_{γ} and information on the pitch-angular velocity value ω_{θ} obtained by the angular velocity sensor unit 215 as the input information (Step 904).

The control apparatus 40 receives the input information (Step 905), generates coordinate values of the pointer 2 in accordance with the input information (Step 906), and controls display of the pointer 2 (Step 907).

The processing of Steps 902 to 904 in FIG. 20 may be executed by the control apparatus 40 as in FIG. 10.

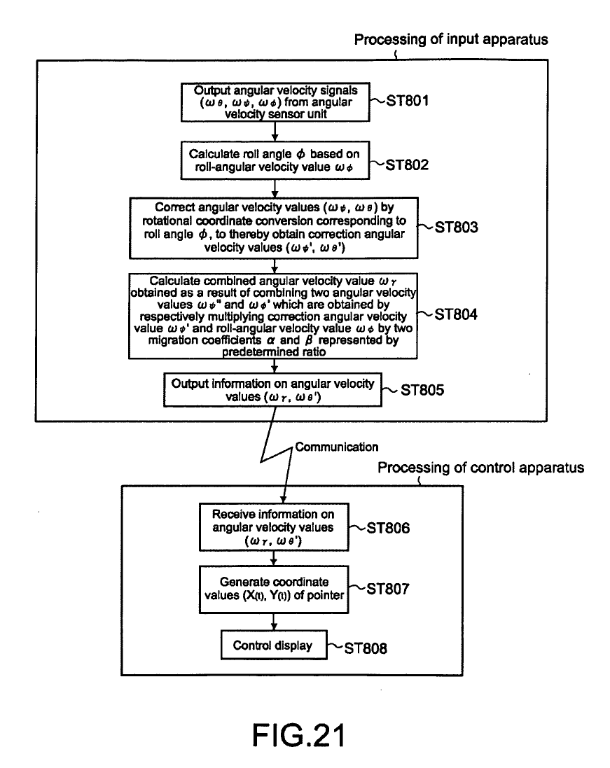

FIG. 21 is a flowchart showing an operation of the control system including the input apparatus 201 according to another embodiment.

Triaxial angular velocity signals are output from the angular velocity sensor unit 215 (Step 801), and the MPU 19 obtains the angular velocity values (ω_{θ}, ω_{ψ}, ω_{φ}). The MPU 19 then calculates the roll angle φ using Equation (7) below (Step 802).

φ=∫ω_{φ}dt (7)

The MPU 19 executes processing the same as that of Steps 1004 to 1006 in FIG. 12 (Steps 803 to 805), and the MPU 35 of the control apparatus 40 executes processing the same as that of Steps 1007 to 1009 in FIG. 12 (Steps 806 to 808).

Integration errors generated in Equation (7) are of no problem since the rotational coordinate conversion corresponding to the roll angle φ is executed in Step 803. Moreover, the initial value ω₀ of the roll angle in Equation (6) is also removed by the rotational coordinate conversion.

The processing of Steps 802 to 805 in FIG. 21 may be executed by the control apparatus 40 as in FIG. 10.

Next, another embodiment swill be described.

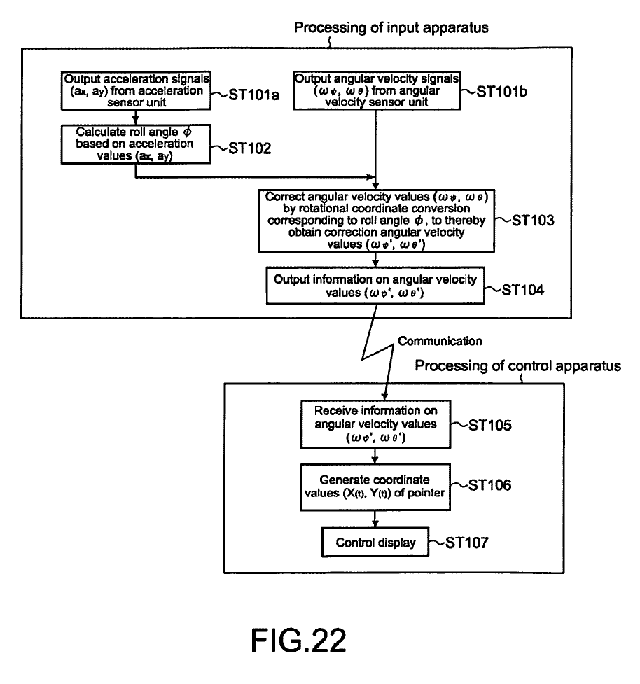

In the above embodiments, the combined angular velocity obtained by combining the angular velocity of the input apparatus 1 in the roll direction and the angular velocity thereof about the X axis has been converted into a displacement amount of the pointer 2 in the X-axis direction. In this embodiment, the angular velocity of the input apparatus 1 in the roll direction is not converted into the displacement amount of the pointer 2 in the X-axis direction, and only the angular velocity of the input apparatus 1 about the X axis is converted into the displacement amount of the pointer 2. FIG. 22 is a flowchart showing an operation of the control system 100 including the processing described above.

Upon turning on the power of the input apparatus 1, biaxial acceleration signals (first and second acceleration values aₓ and a_{y}) are output from the acceleration sensor unit 16 (Step 101a), which are then supplied to the MPU 19. The acceleration signals are signals obtained in the initial position. It is assumed here that the initial position is tilted from the reference position.

The MPU 19 calculates the roll angle φ using Equation (1) based on the gravity acceleration component values (aₓ, a_{y}) (Step 102).

Further, upon turning on the power of the input apparatus 1, biaxial angular velocity signals (first and second angular velocity values ω_{θ} and ω_{ψ}) are output from the angular velocity sensor unit 15 (Step 101b), which are then supplied to the MPU 19.

The MPU 19 corrects the angular velocity values (ω_{ψ}, ω_{θ}) by the rotational coordinate conversion corresponding to the calculated roll angle, to thus obtain correction angular velocity values (second and first correction angular velocity values (ω_{ψ}′, ω_{θ}′)) as correction values (Step 103). Then, the MPU 19 outputs information on the correction angular velocity values (ω_{ψ}′, ω_{θ}′) to the control apparatus 40 (Step 104).

The MPU 35 of the control apparatus 40 receives the information on the correction angular velocity values (ω_{ψ}′, ω_{θ}′) (Step 105). Because the input apparatus 1 outputs the correction angular velocity values (ω_{ψ}′, ω_{θ}′) every predetermined number of clocks, that is, per unit time, the control apparatus 40 can obtain change amounts of a yaw angle and a pitch angle per unit time after receiving the correction angular velocity values (ω_{ψ}′, ω_{θ}′). The MPU 35 generates coordinate values of the pointer 2 on the screen 3, which correspond to the obtained change amounts of the yaw angle ψ(t) and the pitch angle θ(t) per unit time (Step 106). After that, the MPU 35 controls display so that the pointer 2 moves on the screen 3 (Step 107).

It should be noted that when the user operates the input apparatus 1 by actually moving the input apparatus 1 after the effect of the gravity acceleration component generated due to the tilt of the input apparatus 1 in the roll direction has been removed as described above, an acceleration is generated in the input apparatus 1. The acceleration sensor unit 16 detects the acceleration. Thus, it is considered that the roll angle φ calculated in Step 102 fluctuates. Hereinafter, three embodiments for suppressing fluctuations of the roll angle φ as described above will be described.

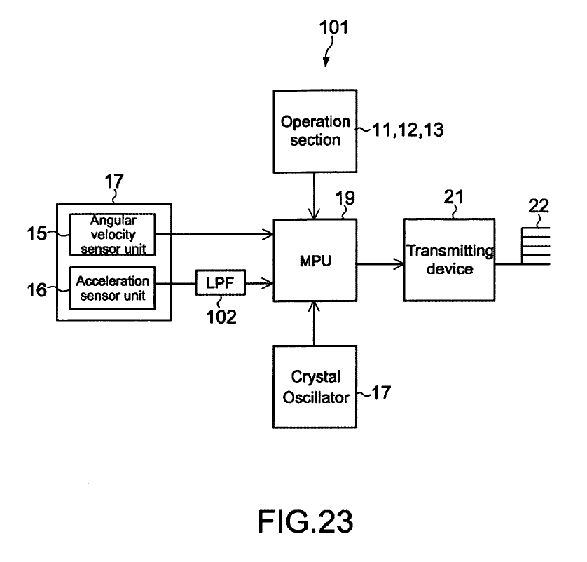

FIG. 23 is a block diagram showing an input apparatus according to one of the three embodiments, i.e., a first embodiment for suppressing fluctuations of the roll angle φ. An input apparatus 101 includes a low-pass filter (LPF) 102 to which at least one of the acceleration signals in the X′- and Y′-axis directions obtained by the acceleration sensor unit 16 is input. The LPF 102 removes impulse-like components within the acceleration signal.

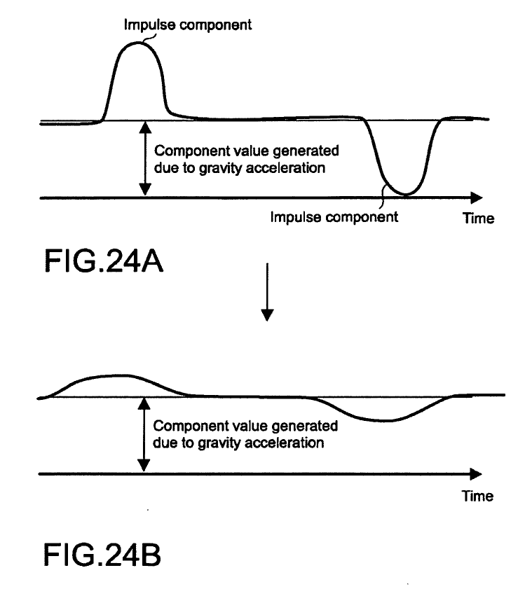

FIG. 24A is a diagram showing the acceleration signal in the X′- or Y′-axis direction obtained before passing through the LPF 102, and FIG. 24B is a diagram showing the acceleration signal obtained after having passed through the LPF 102. The impulse-like components are acceleration signals detected when the user moves the input apparatus 101. DC offset components in the figures are gravity acceleration component values that pass through the LPF 102.

Typically, a waveform of the impulse is ten to several tens of Hz. Thus, the LPF 102 has a cutoff frequency of several Hz. If the cutoff frequency is too low, a delay of φ caused by a phase delay is transferred to the user as awkwardness in operation. Therefore, it is only necessary that a practical lower limit be defined.

As described above, by the LPF 102 removing the impulse-like components, the effect of acceleration generated when the user moves the input apparatus 101 can be removed at the time of calculating the roll angle φ.

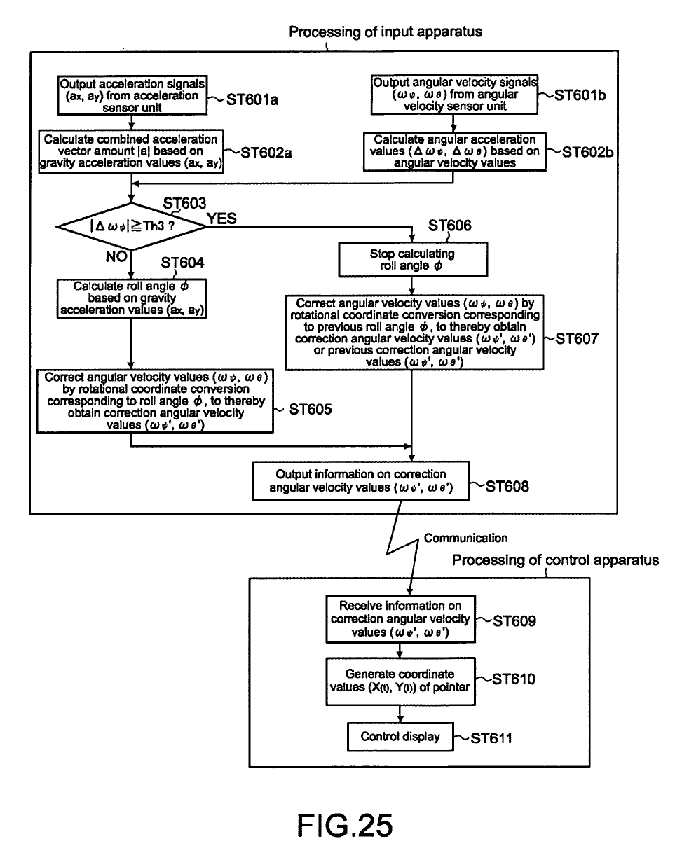

As a second embodiment for suppressing fluctuations of the roll angle φ, there is employed a method in which the angular acceleration values are monitored at the time of calculating the roll angle φ. FIG. 25 is a flowchart showing an operation of the method.

Steps 601a, 601b, and 602a are the same as Steps 301a, 301b, and 302 of FIG. 14. The MPU 19 calculates angular acceleration values (Δω_{ψ}, Δω_{θ}) by a differentiation operation based on the angular velocity values (ω_{ψ}, ω_{θ}) supplied (Step 602b). It should be noted that Steps 602a and 602b are not executed at the same time, and are presented in such a manner for brevity of illustration.

The MPU 19 judges whether an angular velocity value |Δω_{ψ}| in the yaw direction, for example, among angular velocity values calculated in both directions is equal to or larger than a threshold Th3 (Step 603). When |Δω_{ψ}| is equal to or larger than the threshold Th3, the MPU 19 stops calculating the roll angle φ (Step 606). The reason for performing the processing as described above is as follows.

When the user operates the input apparatus 1 naturally, an angular acceleration is generated in the input apparatus 1. The roll angle φ is calculated using Equation (1). Further, the angular velocity value (ω_{θ}, ω_{ψ}) about the X or Y axis is calculated based on the acceleration values (aₓ, a_{y}) using Equation (9) to be described later. Even when an acceleration is generated in the input apparatus 1 when the user moves the input apparatus 1, it is possible to calculate a desired first or second acceleration value for suppressing calculation errors of the roll angle φ within an allowable range by using Equation (3). In other words, it is possible to suppress the calculation errors of the roll angle φ within the allowable range by setting the threshold Th3 of the angular acceleration.

Hereinafter, a description will be given on the threshold Th3 of the angular acceleration.

A description will be given on, for example, the threshold Th3 in a case where, even when the input apparatus 1 is tilted in the pitch direction by θ₁=60 deg when the user moves the input apparatus 1, an error of the roll angle φ resulting from misrecognition of the MPU 19 in the gravity direction caused by an inertial force generated by the tilt is desired to be suppressed to 10 deg or lower.

In the state where the input apparatus 1 is tilted in the pitch direction by 60 deg,

a_{y}=1G*cos 60°=0.5 G

is established. Therefore, with φ=10 deg, Equation (1) is expressed as

10°=arc tan(aₓ/0.5 G)

with the result of aₓ=0.09 G being obtained. Therefore, it is only necessary, that minimum |Δω_{ψ}| be calculated so that aₓ becomes 0.09 G.

Thus, considering a relationship between the acceleration and the angular acceleration generated when the user swings an arm, the larger the radius by which the user swings the input apparatus 1 is, the smaller the angular acceleration |Δω_{ψ}| per acceleration aₓ becomes. Presuming that a maximum radius can be obtained when the user swings the entire arm around a shoulder joint and that a length of the arm is Lₐᵣₘ in this case, Δω_{ψ} can be expressed by Equation (9) below.

|Δω_{ψ}|=aₓ/Lₐᵣₘ (9)

From a typical example in which a length 1 of an arc having a center angle 0 in a circle With a radius r is r0, Equation (9) is established.

When aₓ=0.09 G=0.09*9.8 (m/s) and Lₐᵣₘ=0.8 m (presumably a user with a long arm) are substituted in Equation (9),

Δωx=1.1 rad/s²=63 deg/s²

is established. Specifically, by the MPU 19 stopping the update of φ when an angular acceleration of |Δω_{ψ}|>63°/s² is detected, it becomes possible to suppress the calculation error of the roll angle φ to 10 deg or lower even when the user tilts the input apparatus 1 in the pitch direction by 60 deg at most. A setting range of the calculation error of the roll angle φ is not limited to 10 deg or lower and may suitably be set.

When the user operates the input apparatus 1 using a bending of an elbow or a turn of a wrist, aₓ obtained at the time when the angular acceleration is detected becomes an additionally smaller value. Thus, an error of the angle in the gravity direction caused by the effect of the inertial force is no more than 10°, meaning that the error is reduced.

Processing of Steps 604 to 611 is similar to that of Steps 304, 306, 307, 309, and 311 to 314 in FIG. 14.

Although reference has been made to the angular velocity in the yaw direction in the above descriptions, the same holds true for the angular velocity in the pitch direction. Therefore, a step of judging whether |Δω_{θ}| is equal to or larger than a threshold may be added after Step 603, and when |Δω₀| is equal to or larger than the threshold, the update of the roll angle φ may be stopped.

Incidentally, the operation may be carried out such that the MPU 19 stops calculating the roll angle to carry out the processing of Steps 604 and 607 when at least one of the angular velocities in the yaw and pitch directions is equal to or larger than the threshold. It is known from an experiment that when the user operates the pointer 2 at a fairly high speed (at high angular velocity), e.g., when moving the pointer 2 from an end of the screen 3 to the other end in 0.1 to 0.2 sec, not calculating the roll angle gives less sense of awkwardness to the user. When the user roughly operates the pointer 2 on the screen without any delicate operations as described above, an operation that matches the intuition of the user becomes possible by setting the roll angle to a fixed value. For example, it is only necessary that the calculation of the roll angle be stopped when the output value of the angular velocity sensor 151 or 152 is −200 or less or +200 or more in a case where an output range is set to −512 to +512, the values of which are not limited thereto.

As a third embodiment for suppressing fluctuations of the roll angle φ, there is employed a method in which a threshold is provided to the acceleration detected by the acceleration sensor unit 16. For example, when at least one of the acceleration values (aₓ, a_{y}) detected in the X′- and Y′-axis directions is equal to or larger than the threshold, the MPU 19 stops updating the roll angle φ and resumes the update after the roll angle φ drops below the threshold. Alternatively, the processing may be such that, merely because a detection voltage is saturated when the acceleration value becomes a certain value or more, update of φ is stopped automatically at that time.

The processing of Steps 602a, 602b, and 603 to 607 in FIG. 25 may be executed by the control apparatus 40 as in FIG. 10.

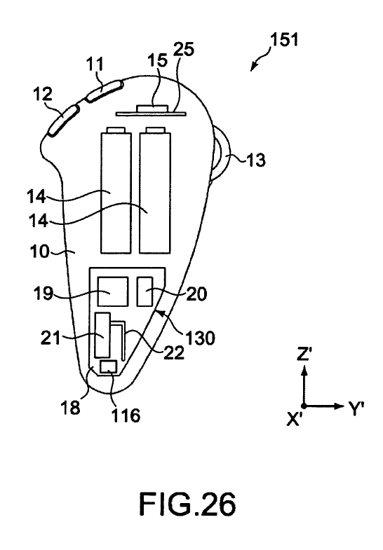

FIG. 26 is a schematic diagram showing a structure of an input apparatus according to another embodiment.

A control unit 130 of an input apparatus 141 includes an acceleration sensor unit 116 disposed at a lower portion of a main substrate 18. The acceleration sensor unit 116 may be a sensor for detecting biaxial accelerations (of X′ axis and Y′ axis) or may be a sensor for detecting tri axial accelerations (of X′ axis, Y′ axis, and Z′ axis).

A position at which the acceleration sensor unit 116 is disposed in the input apparatus 141 is closer to the wrist than the input apparatus 1 when held by the user. By disposing the acceleration sensor unit 116 at the position as described above, an effect of the acceleration generated by a swing of a wrist of the user can be minimized.

Further, by using a triaxial acceleration sensor unit as the acceleration sensor unit 116, for example, though a calculation amount is slightly increased, it is possible to extract the acceleration components in an X′-Y′ plane irrespective of a packaging surface on which the acceleration sensor unit 116 is mounted. As a result, a degree of freedom in layout of the substrate can be increased.

Next, an input apparatus according to another embodiment will be described.

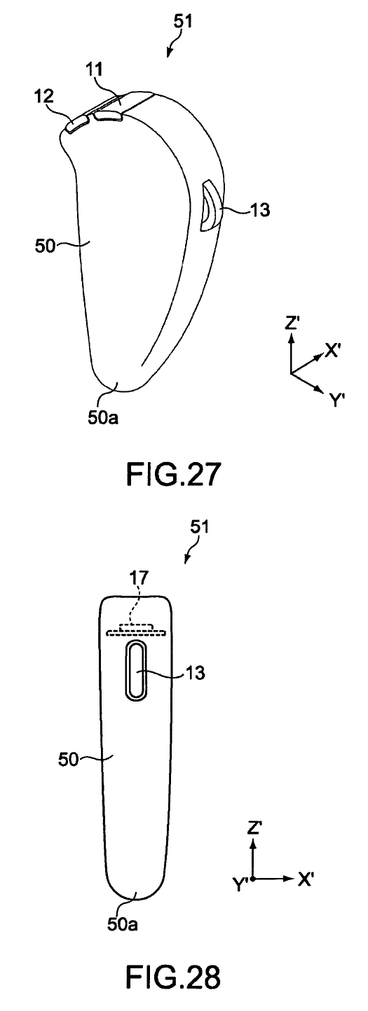

FIG. 27 is a perspective view showing an input apparatus 51 according to this embodiment. FIG. 28 is a side view of the input apparatus 51 seen from the wheel button 13 side. In the following, descriptions on components, functions, and the like similar to those of the input apparatus 1 according to the embodiment described with reference to FIG. 2 and other figures will be simplified or omitted, and points different therefrom will mainly be described.

A casing 50 of the input apparatus 51 includes a partial sphere or partial quadric surface 50a at a predetermined position on a surface of the casing 50. Hereinafter, the partial sphere or quadric surface 50a will be referred to as “lower curved surface 50a” for convenience.

The lower curved surface 50a is formed at a position nearly opposite to the buttons 11 and 12, that is, a position where, when a user holds the input apparatus 51, a pinky is located closer to the lower curved surface 50a than other fingers. Alternatively, in a case where, in the casing 50 elongated in one direction (Z′-axis direction), the sensor unit 17 is provided on a positive side of the Z′ axis with respect to a center of the casing 50 in the Z′-axis direction, the lower curved surface 50a is provided on a negative side of the Z′ axis.

Typically, the partial sphere is substantially a hemisphere, but does not necessarily have to be an exact hemisphere. The quadric surface is a curved surface obtained by expanding a 2-dimensional conic curve (quadric curve) into a 3-dimensional conic curve. Examples of the quadric surface include an ellipsoid surface, an ellipsoid paraboloid surface, and a hyperbolic surface.

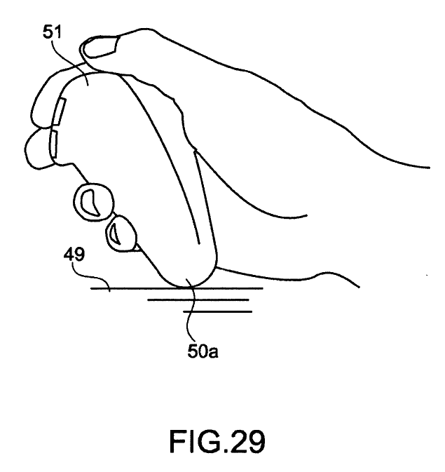

With the configuration of the casing 50 of the input apparatus 51 as described above, the user can easily operate the input apparatus 51 while causing the lower curved surface 50a of the input apparatus 51 as a fulcrum to abut on an abutment target object 49 such as a table, a chair, a floor, or a knee or thigh of a user. That is, even in the state where the lower curved surface 50a of the input apparatus 51 is abutted on the abutment target object 49, the user can easily tilt the input apparatus 51 in diverse angles, thereby enabling delicate operations such as placing the pointer 2 on the icon 4. FIG. 29 is a diagram showing the state where the user operates the input apparatus 51 while causing the lower curved surface 50a thereof to abut on the knee.

Alternatively, in this embodiment, erroneous operations due to shakes, which cannot be suppressed by the shake correction circuit, can be prevented from occurring. Moreover, because a user does not hold and operate the input apparatus 51 in the air, a user can be prevented from becoming fatigued.

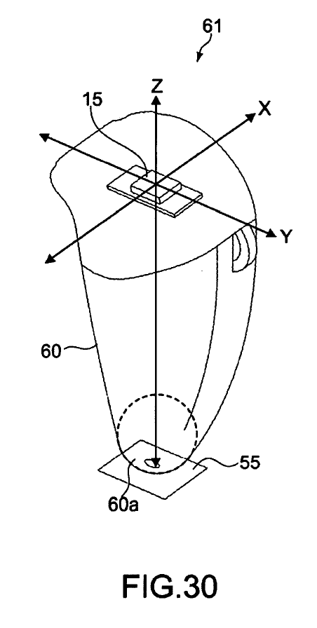

FIG. 30 is a perspective view of an input apparatus according to another embodiment.

A casing 60 of an input apparatus 61 includes, similar to the input apparatus 51 shown in FIGS. 27 and 28, a lower curved surface 60a composed of a partial sphere. A plane perpendicular to a maximum length direction (Z′-axis direction) of the casing 60 of the input apparatus 61 and is in contact with the lower curved surface 60a (hereinafter, referred to as “lower end plane 55” for convenience) is substantially parallel to a plane formed by the X axis and the Y axis (see FIG. 8) as detection axes of the angular velocity sensor unit 15 (X-Y plane).

With the configuration of the input apparatus 61 as described above, in a case where the user operates the input apparatus 61 while causing the lower curved surface 60a to abut on the lower end plane 55, angular velocities applied to the input apparatus 61 are directly input to the angular velocity sensor unit 15. Thus, an amount of calculation required to obtain detection values contained in the detection signals from the angular velocity sensor unit 15 can be reduced.

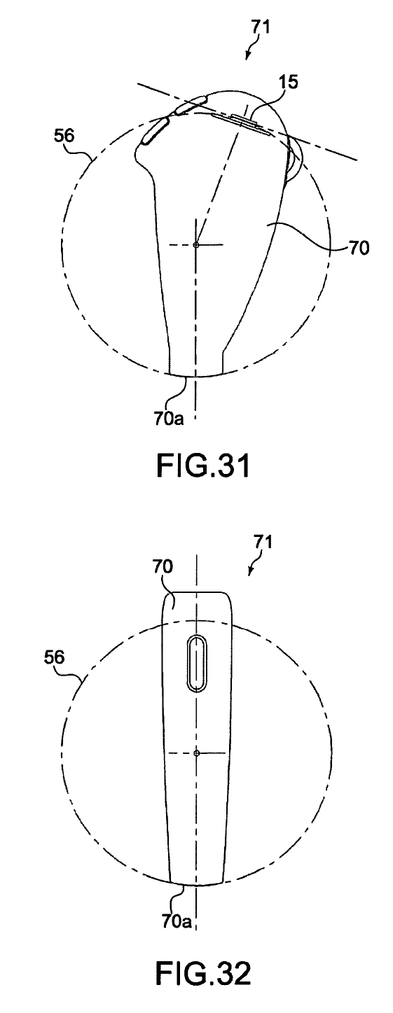

FIG. 31 is a front view showing an input apparatus according to another embodiment. FIG. 32 is a side view showing the input apparatus.

A lower curved surface 70a of a casing 70 of an input apparatus 71 is, for example, a partial sphere. The lower curved surface 70a has a larger curvature radius than the lower curved surfaces 50a and 60a of the input apparatuses 51 and 61 respectively shown in FIGS. 27 and 30. The angular velocity sensor unit 15 is provided at a position at which a straight line contained in the X-Y plane formed by the X axis and the Y axis as the detection axes of the angular velocity sensor unit 15 corresponds to a tangent line of a virtual circle 56 that passes the partial sphere when seen from the X- and Y-axis directions. As long as the conditions as described above are satisfied, the angular velocity sensor unit 15 may be arranged in the casing 70 such that the X-Y plane thereof is tilted with respect to a longitudinal direction of the input apparatus 71 (see FIG. 31).

Accordingly, because a direction of the vector of the angular velocity generated when the user operates the input apparatus 71 while abutting the lower curved surface 70a thereof on the abutment target object 49 and the detection direction of the angular velocity sensor unit 15 match, a linear input is thus enabled.

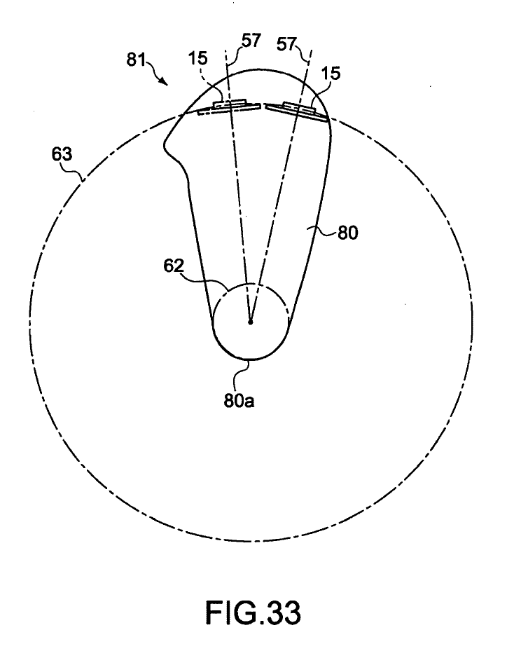

FIG. 33 is a front view of an input apparatus according to another embodiment.

A lower cured surface 80a as a partial sphere of a casing 80 of an input apparatus 81 has a curvature radius the same as or close to that shown in FIG. 30. Regarding the arrangement of the angular velocity sensor unit 15, a virtual straight line that passes an intersection between the X axis and the Y axis, which is a center point of the angular velocity sensor unit 15, and is perpendicular to the X axis and the Y axis passes a center point O of a first sphere 62 including the lower curved surface 80a. With the configuration as described above, the first sphere 62 including the lower curved surface 80a and a second sphere 63 in which the straight line contained in the X-Y plane of the angular velocity sensor unit 15 corresponds to the tangent line thereof are arranged concentrically. Therefore, the input apparatus 81 bears the same effect as that of the input apparatus 71 shown in FIG. 31.

It should be noted that the input apparatus 51, 61, 71, or 81 including the partial sphere or the partial quadric surface described above does not necessarily need to be operated while the lower curved surface 50a, 60a, 70a, or 80a thereof is abutted against the abutment target object 49, and the input apparatus may of course be operated in air.

The input apparatus 51, 61, 71, or 81 shown in FIGS. 27 to 33 may be applied to the input apparatus 201 shown in FIG. 19 and the processing executed by the input apparatus 201, or may be applied to the input apparatus 101 shown in FIG. 23 and the processing executed by the input apparatus 101.

Various modifications to the above embodiments may be made.

In the flowcharts shown in FIGS. 9, 10, 12, 14, 20 to 22, and 25, a part of the processing of the input apparatus may be carried out by the control apparatus or a part of the processing of the control apparatus may be carried out by the input apparatus while the two apparatuses are in communication with each other.

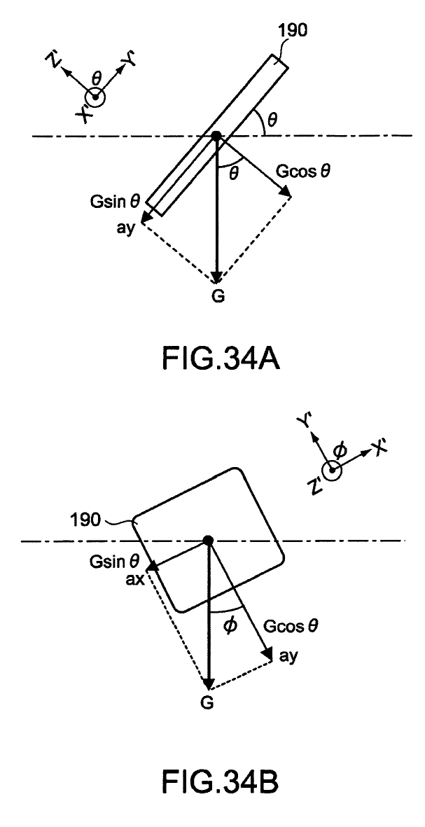

The input apparatus 1 described above is equipped with the acceleration sensor unit 16 and the angular velocity sensor unit 15. However, the input apparatus may include an angle sensor. The angle sensor is, for example, a biaxial angle sensor for detecting an angle (first angle) θ about the X′ axis (first axis) shown in FIG. 34A and an angle (third angle) φ about the Z′ axis shown in FIG. 34B. θ is an angle formed between the vertical axis and the X′-Y′ plane. As a matter of course, the input apparatus may include a triaxial angle sensor for also detecting an angle (second angle) ψ about the Y′ axis (second axis).

The biaxial angle sensor is composed of the acceleration sensor unit 16. As shown in FIG. 34A, G*sin θ as a component of the gravity acceleration G in the Y′ direction is an acceleration value a_{y} in the Y′ direction, which is used to obtain θ. Moreover, as shown in FIG. 34B, φ can be obtained with the angle in the Z′-axis direction as G*sin φ=a_{y} or G*cos φ=aₓ (acceleration component value in the X′ direction). Thus, by calculating the angles θ and φ, ω_{θ} and ω_{φ} can be calculated through the differentiation operation (differentiation means). In this case, the angular velocity (second angular velocity) ψ about the Y′ axis can be obtained directly from the angular velocity sensor.

Alternatively, by calculating one of the angles θ and φ, e.g., only the angle θ (or only the angle φ) by the angle sensor, ω₀ (or ω_{φ}) may be calculated through the differentiation operation. In this case, ω_{φ}(or ω_{θ}) and ω_{ψ} can be obtained directly from the angular velocity sensors.

Even when the input apparatus includes the angle sensor as described above, it is possible for the input apparatus or the control apparatus to carry out the rotational coordinate conversion processing corresponding to the roll angle φ, the multiplication processing using the migration coefficients α and β, and the combination operation processing of combining two angular velocities obtained by the multiplication.

The above-mentioned angle sensor provided instead of or in addition to the acceleration sensor may be a geomagnetic sensor (uniaxial or biaxial) or an image sensor.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An input apparatus for outputting input information for controlling a movement of a user interface displayed on a screen, comprising:
angular velocity output means for outputting a first angular velocity about a first axis, a second angular velocity about a second axis different from the first axis, and a third angular velocity about a third axis perpendicular to both the first axis and the second axis;
combination calculation means for calculating a first combined angular velocity obtained as a result of combining two angular velocities, which are obtained by respectively multiplying the second angular velocity and the third angular velocity by two migration coefficients represented by a predetermined ratio; and
output means for outputting, as the input information, information on the first angular velocity for controlling a movement of the user interface in an axial direction on the screen corresponding to the second axis and information on the first combined angular velocity for controlling the movement of the user interface in an axial direction on the screen corresponding to the first axis.

2. The input apparatus according to claim 11 further comprising:
angle calculation means for calculating an angle about the third axis from an absolute vertical axis based on the third angular velocity; and
rotation correction means for correcting the first angular velocity and the second angular velocity output by the angular velocity output means by rotational coordinate conversion that corresponds to the calculated angle to obtain a first correction angular velocity and a second correction angular velocity, and outputting information of the first correction angular velocity and the second correction angular velocity,
wherein the combination calculation means calculates a second combined angular velocity obtained as a result of combining two angular velocities, which are obtained by respectively multiplying the second correction angular velocity and the third angular velocity by the two migration coefficients, and
wherein the output means outputs information on the second combined angular velocity and the first correction angular velocity as the input information.

3. The input apparatus according to claim 2,
wherein the angle calculation means includes integration means for performing an integration operation of the third angular velocity to calculate an integration value as the angle, and reset means for resetting the integration value.

4. The input apparatus according to claim 1,
wherein the first axis is a pitch axis, the second axis is a yaw axis, and the third axis is a roll axis.

5. The input apparatus according to claim 1,
wherein the angular velocity output means includes an angular velocity sensor configured to detect the first angular velocity, the second angular velocity, and the third angular velocity.

6. The input apparatus according to claim 1,
wherein the angular velocity output means includes
an angle sensor configured to detect a first angle about the first axis and a third angle about the third axis,
an angular velocity sensor configured to detect the second angular velocity, and
differentiation means for calculating the first angular velocity and the third angular velocity through differentiation operations of the first angle and the third angle, respectively.

7. The input apparatus according to claim 6, further comprising rotation correction means for correcting the first angular velocity and the second angular velocity through rotational coordinate conversion that corresponds to the third angle to obtain a first correction angular velocity and a second correction angular velocity, and outputting information on the first correction angular velocity and the second correction angular velocity,
wherein the combination calculation means calculates a second combined angular velocity obtained as a result of combining two angular velocities, which are obtained by respectively multiplying the second correction angular velocity and the third angular velocity by the two migration coefficients, and
wherein the output means outputs information on the second combined angular velocity and the first correction angular velocity as the input information.

8. The input apparatus according to claim 1,
wherein the angular velocity output means includes
an angle sensor configured to detect one of a first angle about the first axis and a third angle about the third axis,
an angular velocity sensor configured to detect the second angular velocity and the third angular velocity when the first angle is detected by the angle sensor, and detect the first angular velocity and the second angular velocity when the third angle is detected by the angle sensor, and
differentiation means for calculating the first angular velocity through a differentiation operation of the first angle when the first angle is detected by the angle sensor, and calculating the third angular velocity through a differentiation operation of the third angle when the third angle is detected by the angle sensor.

9. The input apparatus according to claim 8, further comprising rotation correction means for correcting, when the third angle is detected by the angle sensor, the first angular velocity and the second angular velocity by rotational coordinate conversion that corresponds to the third angle to obtain a first correction angular velocity and a second correction angular velocity, and outputting information on the first correction angular velocity and the second correction angular velocity,
wherein the combination calculation means calculates a second combined angular velocity obtained as a result of combining two angular velocities, which are obtained by respectively multiplying the second correction angular velocity and the third angular velocity by the two migration coefficients, and
wherein the output means outputs information on the second combined angular velocity and the first correction angular velocity as the input information.

10. The input apparatus according to claim 1,
wherein the angular velocity output means includes
an angle sensor configured to detect a first angle about the first axis, a second angle about the second axis, and a third angle about the third axis, and
differentiation means for calculating the first angular velocity, the second angular velocity, and the third angular velocity through differentiation operations of the first angle, the second angle, and the third angle, respectively.

11. The input apparatus according to claim 6, wherein the angle sensor is one of an acceleration sensor, a geomagnetic sensor, and an image sensor.

12. The input apparatus according to claim 8 wherein the angle sensor is one of an acceleration sensor, a geomagnetic sensor, and an image sensor.

13. The input apparatus according to claim 10 wherein the angle sensor is one of an acceleration sensor, a geomagnetic sensor, and an image sensor.

14. A control apparatus for controlling a movement of a user interface displayed on a screen in accordance with input information output from an input apparatus, the input information being information on a first angular velocity about a first axis, a second angular velocity about a second axis different from the first axis, and a third angular velocity about a third axis perpendicular to both the first axis and the second axis, the control apparatus comprising:
reception means for receiving the input information;
combination calculation means for calculating a first combined angular velocity obtained as a result of combining two angular velocities, which are obtained by respectively multiplying the received second angular velocity and the received third angular velocity by two migration coefficients represented by a predetermined ratio; and
coordinate information generation means for generating second coordinate information of the user interface in an axial direction on the screen corresponding to the second axis, the second coordinate information corresponding to the received first angular velocity, and generating first coordinate information of the user interface in an axial direction on the screen corresponding to the first axis, the first coordinate information corresponding to the first combined angular velocity.

15. A control apparatus for controlling a movement of a user interface displayed on a screen in accordance with input information output from an input apparatus, the input information being information on a first angle about a first axis, a second angle about a second axis different from the first axis, and a third angle about a third axis perpendicular to both the first axis and the second axis, the control apparatus comprising:
reception means for receiving the input information;
differentiation means for performing differentiation operations of the received first angle, the received second angle, and the received third angle, to calculate a first angular velocity, a second angular velocity, and a third angular velocity, respectively;
combination calculation means for calculating a first combined angular velocity obtained as a result of combining two angular velocities, which are obtained by respectively multiplying the second angular velocity and the third angular velocity by two migration coefficients represented by a predetermined ratio; and
coordinate information generation means for generating second coordinate information of the user interface in an axial direction on the screen corresponding to the second axis, the second coordinate information corresponding to the first angular velocity, and generating first coordinate information of the user interface in an axial direction on the screen corresponding to the first axis, the first coordinate information corresponding to the first combined angular velocity.

16. A control system, comprising:
an input apparatus including
angular velocity output means for outputting a first angular velocity about a first axis, a second angular velocity about a second axis different from the first axis, and a third angular velocity about a third axis perpendicular to both the first axis and the second axis,
combination calculation means for calculating a first combined angular velocity obtained as a result of combining two angular velocities, which are obtained by respectively multiplying the second angular velocity and the third angular velocity by two migration coefficients represented by a predetermined ratio, and
output means for outputting, as input information, information on the first angular velocity and information on the first combined angular velocity; and
a control apparatus including
reception means for receiving the input information, and
coordinate information generation means for generating second coordinate information of a user interface displayed on a screen in an axial direction on the screen corresponding to the second axis, the second coordinate information corresponding to the received first angular velocity, and generating first coordinate information of the user interface in an axial direction on the screen corresponding to the first axis, the first coordinate information corresponding to the first combined angular velocity.

17. A control system, comprising:
an input apparatus including
angular velocity output means for outputting a first angular velocity about a first axis, a second angular velocity about a second axis different from the first axis, and a third angular velocity about a third axis perpendicular to both the first axis and the second axis, and
output means for outputting information on the first angular velocity, the second angular velocity, and the third angular velocity as input information; and
a control apparatus including
reception means for receiving the input information,
combination calculation means for calculating a first combined angular velocity obtained as a result of combining two angular velocities, which are obtained by respectively multiplying the received second angular velocity and the received third angular velocity by two migration coefficients represented by a predetermined ratio, and
coordinate information generation means for generating second coordinate information of a user interface displayed on a screen in an axial direction on the screen corresponding to the second axis, the second coordinate information corresponding to the received first angular velocity, and generating first coordinate information of the user interface in an axial direction on the screen corresponding to the first axis, the first coordinate information corresponding to the first combined angular velocity.

18. A method of controlling a user interface on a screen in accordance with a movement of an input apparatus, the method comprising:
detecting a first angular velocity of the input apparatus about a first axis;
detecting a second angular velocity of the input apparatus about a second axis different from the first axis;
detecting a third angular velocity of the input apparatus about a third axis perpendicular to both the first axis and the second axis;
calculating a first combined angular velocity obtained as a result of combining two angular velocities, which are obtained by respectively multiplying the second angular velocity and the third angular velocity by two migration coefficients represented by a predetermined ratio;
generating first coordinate information of the user interface in an axial direction on the screen corresponding to the first axis, the first coordinate information corresponding to the first combined angular velocity; and
generating second coordinate information of the user interface in an axial direction on the screen corresponding to the second axis, the second coordinate information corresponding to the first angular velocity.

19. An input apparatus configured to output input information for controlling a movement of a user interface displayed on a screen, comprising:
a first acceleration sensor configured to detect a first acceleration in a direction along a first axis:
a second acceleration sensor configured to detect a second acceleration in a direction along a second axis different from the first axis;
a first angular velocity sensor configured to detect a first angular velocity about the first axis;
a second angular velocity sensor configured to detect a second angular velocity about the second axis;
angle calculation means for calculating, based on the first acceleration and the second acceleration, an angle about a third axis perpendicular to both the first axis and the second axis, the angle being formed between a combined acceleration vector of the first acceleration and the second acceleration and the second axis;
angular velocity calculation means for calculating a third angular velocity about the third axis based on the calculated angle;
rotation correction means for correcting the first angular velocity and the second angular velocity by rotational coordinate conversion that corresponds to the calculated angle to obtain a first correction angular velocity and a second correction angular velocity, and outputting information on the first correction angular velocity and the second correction angular velocity;
combination calculation means for calculating a combined angular velocity obtained as a result of combining two angular velocities, which are obtained by respectively multiplying the second correction angular velocity and the third angular velocity by two migration coefficients represented by a predetermined ratio; and
output means for outputting, as the input information, information on the first correction angular velocity for controlling a movement of the user interface in an axial direction on the screen corresponding to the second axis and information on the combined angular velocity for controlling the movement of the user interface in an axial direction on the screen corresponding to the first axis.

20. A control apparatus configured to control a movement of a user interface displayed on a screen in accordance with input information output by an input apparatus including a first acceleration sensor configured to detect a first acceleration in a direction along a first axis, a second acceleration sensor configured to detect a second acceleration in a direction along a second axis different from the first axis, a first angular velocity sensor configured to detect a first angular velocity about the first axis, and a second angular velocity sensor configured to detect a second angular velocity about the second axis, the input information being information on the first acceleration, the second acceleration, the first angular velocity, and the second angular velocity, the control apparatus comprising:
reception means for receiving the input information;
angle calculation means for calculating, based on the first acceleration and the second acceleration, an angle about a third axis perpendicular to both the first axis and the second axis, the angle being formed between a combined acceleration vector of the received first acceleration and the received second acceleration and the second axis;
angular velocity calculation means for calculating a third angular velocity about the third axis based on the calculated angle;
rotation correction means for correcting the received first angular velocity and the received second angular velocity by rotational coordinate conversion that corresponds to the calculated angle to obtain a first correction angular velocity and a second correction angular velocity, and outputting information on the first correction angular velocity and the second correction angular velocity;
combination calculation means for calculating a combined angular velocity obtained as a result of combining two angular velocities, which are obtained by respectively multiplying the second correction angular velocity and the third angular velocity by two migration coefficients represented by a predetermined ratio; and
coordinate information generation means for generating second coordinate information of the user interface in an axial direction on the screen corresponding to the second axis, the second coordinate information corresponding to the first correction angular velocity, and generating first coordinate information of the user interface in an axial direction on the screen corresponding to the first axis, the first coordinate information corresponding to the combined angular velocity.

21. A method of controlling a user interface on a screen in accordance with a movement of an input apparatus, the method comprising:
detecting a first acceleration of the input apparatus in a direction along a first axis;
detecting a second acceleration of the input apparatus in a direction along a second axis different from the first axis;
detecting a first angular velocity of the input apparatus about the first axis:
detecting a second angular velocity of the input apparatus about the second axis;
calculating, based on the first acceleration and the second acceleration, an angle about a third axis perpendicular to both the first axis and the second axis the angle being formed between a combined acceleration vector of the first acceleration and the second acceleration and the second axis;
calculating a third angular velocity about the third axis based on the calculated angle;
correcting the first angular velocity and the second angular velocity by rotational coordinate conversion that corresponds to the calculated angle to obtain a first correction angular velocity and a second correction angular velocity;
outputting information on the first correction angular velocity and the second correction angular velocity;
calculating a combined angular velocity obtained as a result of combining two angular velocities, which are obtained by respectively multiplying the second correction angular velocity and the third angular velocity by two migration coefficients represented by a predetermined ratio;
generating second coordinate information of the user interface in an axial direction on the screen corresponding to die second axis, the second coordinate information corresponding to the first correction angular velocity; and
generating first coordinate information of the user interface in an axial direction on the screen corresponding to the first axis, the first coordinate information corresponding to the combined angular velocity.

22. An input apparatus configured to output input information for controlling a movement of a user interface displayed on a screen, the input apparatus comprising:
an angular velocity output unit configured to output a first angular velocity about a first axis, a second angular velocity about a second axis different from the first axis, and a third angular velocity about a third axis perpendicular to both the first axis and the second axis;
a combination calculation unit configured to calculate a first combined angular velocity obtained as a result of combining two angular velocities, which are obtained by respectively multiplying the second angular velocity and the third angular velocity by two migration coefficients represented by a predetermined ratio; and
an output unit configured to output, as the input information, information on the first angular velocity for controlling a movement of the user interface in an axial direction on the screen corresponding to the second axis and information on the first combined angular velocity for controlling the movement of the user interface in an axial direction on the screen corresponding to the first axis.

23. A control apparatus configured to control a movement of a user interface displayed on a screen in accordance with input information output from a input apparatus, the input information being information on a first angular velocity about a first axis, a second angular velocity about a second axis different from the first axis, and a third angular velocity about a third axis perpendicular to both the first axis and the second axis, the control apparatus comprising:
a reception unit configured to receive the input information;
a combination calculation unit configured to calculate a first combined angular velocity obtained as a result of combining two angular velocities, which are obtained by respectively multiplying the received second angular velocity and the received third angular velocity by two migration coefficients represented by a predetermined ratio; and
a coordinate information generation unit configured to generate second coordinate information of the user interface in an axial direction on the screen corresponding to the second axis, the second coordinate information corresponding to the received first angular velocity, and generate first coordinate information of the user interface in an axial direction on the screen corresponding to the first axis, the first coordinate information corresponding to the first combined angular velocity.

24. A control apparatus configured to control a movement of a user interface displayed on a screen in accordance with input information output from an input apparatus, the input information being information on a first angle about a first axis, a second angle about a second axis different from the first axis, and a third angle about a third axis perpendicular to both the first axis and the second axis, the control apparatus comprising:
a reception unit configured to receive the input information;
a differentiation unit configured to calculate a first angular velocity, a second angular velocity, and a third angular velocity through differentiation operations of the received first angle, the received second angle, and the received third angle, respectively;
a combination calculation unit configured to calculate a first combined angular velocity obtained as a result of combining two angular velocities, which are obtained by respectively multiplying the second angular velocity and the third angular velocity by two migration coefficients represented by a predetermined ratio; and
a coordinate information generation unit configured to generate second coordinate information of the user interface in an axial direction on the screen corresponding to the second axis, the second coordinate information corresponding to the first angular velocity, and generate first coordinate information of the user interface in an axial direction on the screen corresponding to the first axis, the first coordinate information corresponding to the first combined angular velocity.

25. A control system comprising:
an input apparatus including
an angular velocity output unit configured to output a first angular velocity about a first axis, a second angular velocity about a second axis different from the first axis, and a third angular velocity about a third axis perpendicular to both the first axis and the second axis,
a combination calculation unit configured to calculate a first combined angular velocity obtained as a result of combining two angular velocities, which are obtained by respectively multiplying the second angular velocity and the third angular velocity by two migration coefficients represented by a predetermined ratio, and
an output unit configured to output, as input information, information on the first angular velocity and information on the first combined angular velocity; and
a control apparatus including
a reception unit configured to receive the input information, and
a coordinate information generation unit configured to generate second coordinate information of a user interface displayed on a screen in an axial direction on the screen corresponding to the second axis, the second coordinate information corresponding to the received first angular velocity, and generate first coordinate information of the user interface in an axial direction on the screen corresponding to the first axis, the first coordinate information corresponding to the first combined angular velocity.

26. A control system comprising:
an input apparatus including
an angular velocity output unit configured to output a first angular velocity about a first axis, a second angular velocity about a second axis different from the first axis, and a third angular velocity about a third axis perpendicular to both the first axis and the second axis, and
an output unit configured to output information on the first angular velocity, the second angular velocity, and the third angular velocity as input information; and
a control apparatus including
a reception unit configured to receive the input information,
a combination calculation unit configured to calculate a first combined angular velocity obtained as a result of combining two angular velocities, which are obtained by respectively multiplying the received second angular velocity and the received third angular velocity by two migration coefficients represented by a predetermined ratio, and
a coordinate information generation unit configured to generate second coordinate information of a user interface displayed on a screen in an axial direction on the screen corresponding to the second axis, the second coordinate information corresponding to the received first angular velocity, and generate first coordinate information of the user interface in an axial direction on the screen corresponding to the first axis, the first coordinate information corresponding to the first combined angular velocity.

27. A control apparatus configured to control a movement of a user interface displayed on a screen in accordance with input information output by an input apparatus including a first acceleration sensor configured to detect a first acceleration in a direction along a first axis, a second acceleration sensor configured to detect a second acceleration in a direction along a second axis different from the first axis, a first angular velocity sensor configured to detect a first angular velocity about the first axis, and a second angular velocity sensor configured to detect a second angular velocity about the second axis, the input information being information on the first acceleration, the second acceleration, the first angular velocity, and the second angular velocity, the control apparatus comprising:
a reception unit configured to receive the input information;
an angle calculation unit configured to calculate, based on the first acceleration and the second acceleration, an angle about a third axis perpendicular to both the first axis and the second axis, the angle being an angle formed between a combined acceleration vector of the received first acceleration and the received second acceleration and the second axis;
an angular velocity calculation unit configured to calculate a third angular velocity about the third axis based on the calculated angle;
a rotation correction unit configured to correct the received first angular velocity and the received second angular velocity by rotational coordinate conversion that corresponds to the calculated angle to obtain a first correction angular velocity and a second correction angular velocity, and output information on the first correction angular velocity and the second correction angular velocity;
a combination calculation unit configured to calculate a combined angular velocity obtained as a result of combining two angular velocities, which are obtained by respectively multiplying the second correction angular velocity and the third angular velocity by two migration coefficients represented by a predetermined ratio; and
a coordinate information generation unit configured to generate second coordinate information of the user interface in an axial direction on the screen corresponding to the second axis, the second coordinate information corresponding to the received first correction angular velocity, and generate first coordinate information of the user interface in an axial direction on the screen corresponding to the first axis, the first coordinate information corresponding to the combined angular velocity.
